(19) United States
(12) Patent Application Publication
(10) Pub. No.: US 2026/0362539 A1
(43) Pub. Date: Nov. 12, 2026

(54) DEVICE AND METHOD FOR PERFORMING ONLINE TRAINING WITH RESPECT TO RECEIVER MODEL IN WIRELESS COMMUNICATION SYSTEM

(71) Applicant: LG Electronics Inc., Seoul (KR)

(72) Inventors: Kyungho LEE, Seoul (KR); Bonghoe KIM, Seoul (KR); Sangrim LEE, Seoul (KR); Yeongjun KIM, Seoul (KR)

(21) Appl. No.: 19/103,093

(22) PCT Filed: Aug. 11, 2022
(86) PCT No.: PCT/KR2022/012014

§ 371 Date: Feb. 11, 2025

(51) Int. Cl. H04W 76/28; G06N 3/08

(52) U.S. Cl. CPC H04W 76/28; G06N 3/08

(57) ABSTRACT

The present disclosure relates to performing online training with respect to a receiver model in a wireless communication system, and a method for operating a user equipment (UE) may include receiving broadcast information necessary for communication, transmitting capability information related to discontinuous reception (DRX), receiving configuration information related to the DRX, performing a sleep duration operation based on the configuration information, and performing an on-duration operation based on the configuration information. The on-duration operation may include an operation of monitoring a UE context that is used to configure a receiver, and the sleep duration operation may include an operation of configuring the receiver by using channel data that is generated based on the UE context.

### TECHNICAL FIELD

The present disclosure relates to a wireless communication system, and more particularly, to a device and method for performing online training with respect to a receiver model in a wireless communication system.

### BACKGROUND ART

Radio access systems have come into widespread in order to provide various types of communication services such as voice or data. In general, a radio access system is a multiple access system capable of supporting communication with multiple users by sharing available system resources (bandwidth, transmit power, etc.). Examples of the multiple access system include a code division multiple access (CDMA) system, a frequency division multiple access (FDMA) system, a time division multiple access (TDMA) system, a single carrier-frequency division multiple access (SC-FDMA) system, etc.

In particular, as many communication apparatuses require a large communication capacity, an enhanced mobile broadband (eMBB) communication technology has been proposed compared to radio access technology (RAT). In addition, not only massive machine type communications (mMTC) for providing various services anytime anywhere by connecting a plurality of apparatuses and things but also communication systems considering services/user equipments (UEs) sensitive to reliability and latency have been proposed. To this end, various technical configurations have been proposed.

### DISCLOSURE

### Technical Problem

The present disclosure may provide an apparatus and method for effectively performing online learning for a receiver model in a wireless communication system.

The present disclosure may provide an apparatus and method for performing active learning for a receiver model in a wireless communication system.

The present disclosure may provide an apparatus and method for reducing a burden of separately updating different receiver models held by a plurality of terminals in a wireless communication system.

The present disclosure may provide an apparatus and method for performing training for a plurality of receiver models for different tasks by using a common channel generative model for the receiver models in a wireless communication system.

The present disclosure may provide an apparatus and method for controlling an output of a channel generative model according to a channel environment in a wireless communication system.

The present disclosure may provide an apparatus and method for operating a channel generative model based on a probability distribution corresponding to a channel environment in a wireless communication system.

The present disclosure may provide an apparatus and method for determining a probability distribution corresponding to a channel environment in a wireless communication system.

The present disclosure may provide an apparatus and method for controlling an output of a channel generative model according to a context of a terminal in a wireless communication system.

The present disclosure may provide an apparatus and method for controlling an output of a channel generative model according to uncertainty for a receiver model of a terminal in a wireless communication system.

The present disclosure may provide an apparatus and method for performing online training for a receiver model during a discontinuous reception (DRX) operation of a terminal in a wireless communication system.

The present disclosure may provide an apparatus and method for performing online learning for a receiver model during a sleep duration according to a DRX operation of a terminal in a wireless communication system.

The present disclosure may provide an apparatus and method for determining a length of an online learning period based on a measurement result during a wake-up duration according to a DRX operation of a terminal in a wireless communication system.

Technical objects to be achieved in the present disclosure are not limited to what is mentioned above, and other technical objects not mentioned therein can be considered from the embodiments of the present disclosure to be described below by those skilled in the art to which a technical configuration of the present disclosure is applied.

### Technical Solution

As an example of the present disclosure, a method for operating a user equipment (UE) in a wireless communication system may include receiving broadcast information necessary for communication, transmitting capability information related to discontinuous reception (DRX), receiving configuration information related to the DRX, performing a sleep duration operation based on the configuration information, and performing an on-duration operation based on the configuration information. The on-duration operation may include an operation of monitoring a UB context that is used to configure a receiver, and the sleep duration operation may include an operation of configuring the receiver by using channel data that is generated based on the UE context.

As an example of the present disclosure, a method for operating a base station in a wireless communication system may include transmitting broadcast information necessary for communication, receiving capability information related to discontinuous reception (DRX), transmitting configuration information related to the DRX, receiving a message for requesting information or a signal necessary for configuring a receiver of a user equipment (UE), and transmitting the information or the signal. The configuration information may indicate a sleep duration and an on-duration for a DRX operation of the UE. The on-duration may be used to monitor a UE context that is used to configure the receiver in the UE. The sleep duration may be used to configure the receiver by using channel data that is generated in the UE based on the UE context.

As an example of the present disclosure, a user equipment (UE) in a wireless communication system may include a transceiver and a processor coupled with the transceiver. The processor may be configured to receive broadcast information necessary for communication, to transmit capability information related to discontinuous reception (DRX), to receive configuration information related to the DRX, to perform a sleep duration operation based on the configuration information, and to perform an on-duration operation based on the configuration information. The on-duration operation may include an operation of monitoring a UE context that is used to configure a receiver, and the sleep duration operation may include an operation of configuring the receiver by using channel data that is generated based on the UE context.

As an example of the present disclosure, a base station in a wireless communication may include a transceiver and a processor coupled with the transceiver. The processor may be configured to transmit broadcast information necessary for communication, to receive capability information related to discontinuous reception (DRX), to transmit configuration information related to the DRX, to receive a message for requesting information or a signal necessary for configuring a receiver of a user equipment (UE), and to transmit the information or the signal. The configuration information may indicate a sleep duration and an on-duration for a DRX operation of the UE. The on-duration may be used to monitor a UE context that is used to configure the receiver. The sleep duration may be used to configure the receiver by using channel data that is generated in the UE based on the UE context.

As an example of the present disclosure, a communication device may include at least one processor and at least one computer memory coupled with the at least one processor and storing an instruction that instructs operations when executed by the at least one processor. The operations may include receiving broadcast information necessary for communication, transmitting capability information related to discontinuous reception (DRX), receiving configuration information related to the DRX, performing a sleep duration operation based on the configuration information, and performing an on-duration operation based on the configuration information. The on-duration operation may include an operation of monitoring a UE context that is used to configure a receiver, and the sleep duration operation may include an operation of configuring the receiver by using channel data that is generated based on the UE context.

As an example of the present disclosure, a non-transitory computer-readable medium storing at least one instruction may include the at least one instruction that is executable by a processor. The at least one instruction may control a device to receive broadcast information necessary for communication, to transmit capability information related to discontinuous reception (DRX), to receive configuration information related to the DRX, to perform a sleep duration operation based on the configuration information, and to perform an on-duration operation based on the configuration information. The on-duration operation may include an operation of monitoring a UE context that is used to configure a receiver, and the sleep duration operation may include an operation of configuring the receiver by using channel data that is generated based on the UE context.

The above-described aspects of the present disclosure are merely a part of exemplary embodiments of the present disclosure, and various embodiments reflecting technical features of the present disclosure may be derived and understood by those skilled in the art based on the detailed description of the present disclosure below.

### Advantageous Effects

As is apparent from the above description, the embodiments of the present disclosure have the following effects.

According to the present disclosure, online learning for a receiver model may be effectively performed.

Effects obtained in the present disclosure are not limited to the above-mentioned effects, and other effects not mentioned above may be clearly derived and understood by those skilled in the art, to which a technical configuration of the present disclosure is applied, from the following description of embodiments of the present disclosure. That is, effects, which are not intended when implementing a configuration described in the present disclosure, may also be derived by those skilled in the art from the embodiments of the present disclosure.

### DESCRIPTION OF DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 illustrates an example of a communication system applicable to the present disclosure.

FIG. 2 illustrates an example of a wireless apparatus applicable to the present disclosure.

FIG. 3 illustrates another example of a wireless device applicable to the present disclosure.

FIG. 4 illustrates an example of a hand-held device applicable to the present disclosure.

FIG. 5 illustrates an example of a car or an autonomous driving car applicable to the present disclosure.

FIG. 6 illustrates an example of artificial intelligence (AI) device applicable to the present disclosure.

FIG. 7 illustrates a method of processing a transmitted signal applicable to the present disclosure.

FIG. 8 illustrates an example of a communication structure providable in a 6th generation (6G) system applicable to the present disclosure.

FIG. 9 illustrates an electromagnetic spectrum applicable to the present disclosure.

FIG. 10 illustrates a THz communication method applicable to the present disclosure.

FIG. 11 illustrates a perceptron architecture in an artificial neural network applicable to the present disclosure.

FIG. 12 illustrates an artificial neural network architecture applicable to the present disclosure.

FIG. 13 illustrates a deep neural network applicable to the present disclosure.

FIG. 14 illustrates a convolutional neural network applicable to the present disclosure.

FIG. 15 illustrates a filter operation of a convolutional neural network applicable to the present disclosure.

FIG. 16 illustrates a neural network architecture with a recurrent loop applicable to the present disclosure.

FIG. 17 illustrates an operational structure of a recurrent neural network applicable to the present disclosure.

FIG. 18 illustrates sampling methods for active learning according to an embodiment of the present disclosure.

FIG. 19A to FIG. 19C illustrate examples of results of active learning and passive learning according to an embodiment of the present disclosure.

FIG. 20 illustrates functional structures of devices supporting active learning according to an embodiment of the present disclosure.

FIG. 20 illustrates examples of regions distinguished according to a latent distribution according to an embodiment of the present disclosure.

FIG. 22 illustrates examples of timesteps at which context monitoring is performed during a discontinuous reception (DRX) cycle according to an embodiment of the present disclosure.

FIG. 23 illustrates examples of timesteps at which online learning is performed during a DRX cycle according to an embodiment of the present disclosure.

FIG. 24 illustrates an example of a procedure of configuring a receiver during a DRX mode operation according to an embodiment of the present disclosure.

FIG. 25 illustrates an example of a procedure of responding to a change of context information according to an embodiment of the present disclosure.

FIG. 26 illustrates an example of a procedure of responding to an increase of uncertainty according to an embodiment of the present disclosure.

FIG. 27 illustrates an example of a procedure of supporting online learning according to an embodiment of the present disclosure.

FIG. 28 illustrates an example of a procedure of exchanging capability information related to online learning according to an embodiment of the present disclosure.

FIG. 29 illustrates an example of a procedure of updating latent distribution information according to an embodiment of the present disclosure.

FIG. 30 illustrates an example of a procedure of controlling uncertainty of a receiver model according to an embodiment of the present disclosure.

FIG. 31 illustrates examples of various neural networks for different tasks according to an embodiment of the present disclosure.

FIG. 32 illustrates examples of timesteps at which context measurement and online learning are performed during a DRX cycle according to an embodiment of the present disclosure.

FIG. 33 illustrates examples of context groups according to an embodiment of the present disclosure.

FIG. 34 illustrates other examples of context groups according to an embodiment of the present disclosure.

FIG. 35 illustrates examples of terminals with different channel task networks according to an embodiment of the present disclosure.

### MODE FOR INVENTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an advanced base station (ABS), an access point, etc.

In the embodiments of the present disclosure, the term terminal may be replaced with a UE, a mobile station (MS), a subscriber station (SS), a mobile subscriber station (MSS), a mobile terminal, an advanced mobile station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 36.211, 3GPP TS 36.212, 3GPP TS 36.213, 3GPP TS 36.321 and 3GPP TS 36.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.xxx.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

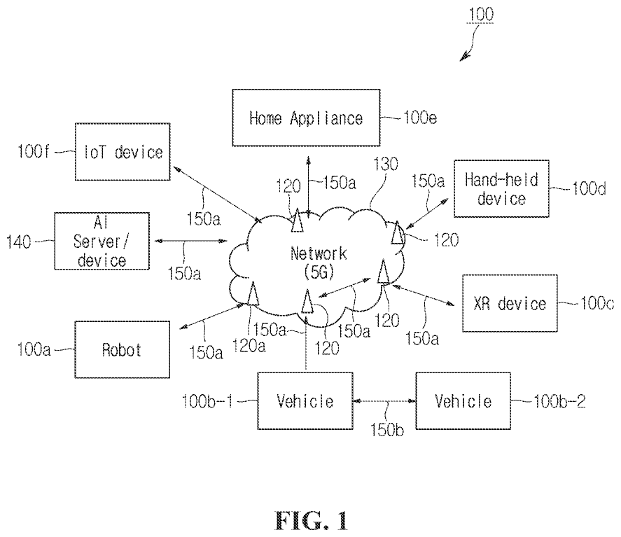

FIG. 1 illustrates an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (LAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

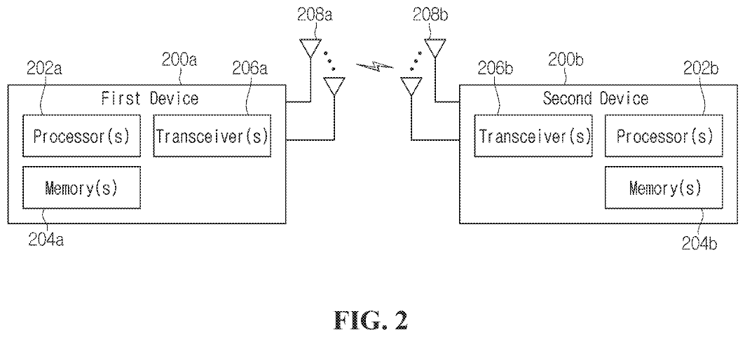

FIG. 2 illustrates an example of a wireless device applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be coupled with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be coupled with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be coupled with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be coupled with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

### Structure of Wireless Device Applicable to the Present Disclosure

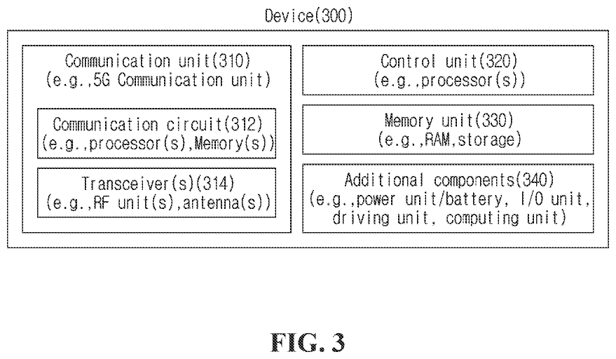

FIG. 3 illustrates another example of a wireless device applicable to the present disclosure.

Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device a based on program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIGS. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

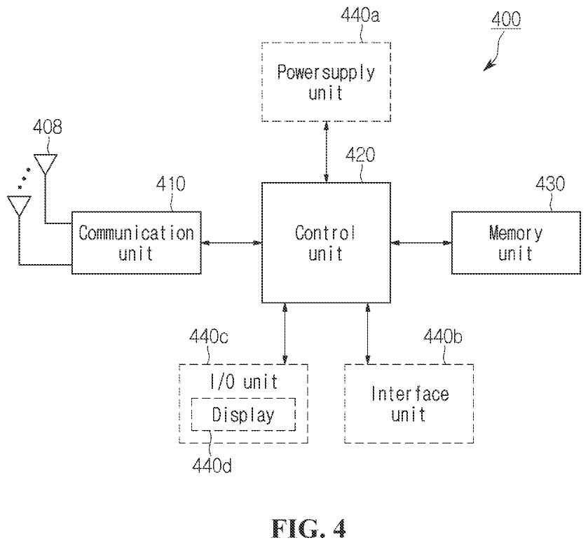

FIG. 4 illustrates an example of a hand-held device applicable to the present disclosure.

FIG. 4 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 4, the hand-held device 400 may include an antenna unit (antenna) 408, a communication unit (transceiver) 410, a control unit (controller) 420, a memory unit (memory) 430, a power supply unit (power supply) 440a, an interface unit (interface) 440b, and an input/output unit 440c. An antenna unit (antenna) 408 may be part of the communication unit 410. The blocks 410 to 430/440a to 440c may correspond to the blocks 310 to 330/340 of FIG. 3, respectively.

The communication unit 410 may transmit and receive signals (e.g., data, control signals, etc.) to and from other wireless devices or base stations. The control unit 420 may control the components of the hand-held device 400 to perform various operations. The control unit 420 may include an application processor (AP). The memory unit 430 may store data/parameters/program/code/instructions necessary to drive the hand-held device 400. In addition, the memory unit 430 may store input/output data/information, etc. The power supply unit 440a may supply power to the hand-held device 400 and include a wired/wireless charging circuit, a battery, etc. The interface unit 440b may support connection between the hand-held device 400 and another external device. The interface unit 440b may include various ports (e.g., an audio input/output port and a video input/output port) for connection with the external device. The input/output unit 440c may receive or output video information/signals, audio information/signals, data and/or user input information. The input/output unit 440c may include a camera, a microphone, a user input unit, a display 440d, a speaker and/or a haptic module.

For example, in case of data communication, the input/output unit 440c may acquire user input information/signal (e.g., touch, text, voice, image or video) from the user and store the user input information/signal in the memory unit 430. The communication unit 410 may convert the information/signal stored in the memory into a radio signal and transmit the converted radio signal to another wireless device directly or transmit the converted radio signal to a base station. In addition, the communication unit 410 may receive a radio signal from another wireless device or the base station and then restore the received radio signal into original information/signal. The restored information/signal may be stored in the memory unit 430 and then output through the input/output unit 440c in various forms (e.g., text, voice, image, video and haptic).

### Type of Wireless Device Applicable to the Present Disclosure

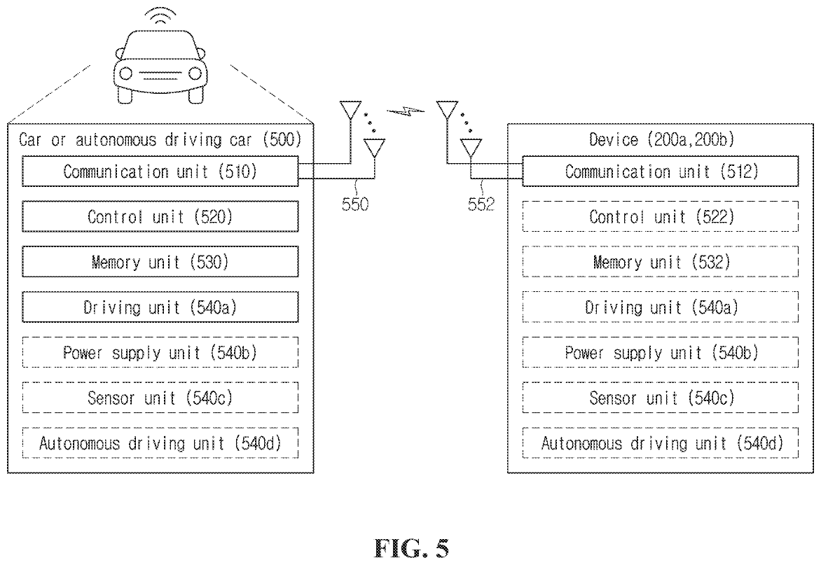

FIG. 5 illustrates an example of a car or an autonomous driving car applicable to the present disclosure.

FIG. 5 shows a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited.

Referring to FIG. 5, the car or autonomous driving car 500 may include an antenna unit (antenna) 508, a communication unit (transceiver) 510, a control unit (controller) 520, a driving unit 540a, a power supply unit (power supply) 540b, a sensor unit 540c, and an autonomous driving unit 540d. The antenna unit 550 may be configured as part of the communication unit 510. The blocks 510/530/540a to 540d correspond to the blocks 410/430/440 of FIG. 4.

The communication unit 510 may transmit and receive signals (e.g., data, control signals, etc.) to and from external devices such as another vehicle, a base station (e.g., a base station, a road side unit, etc.), and a server. The control unit 520 may control the elements of the car or autonomous driving car 500 to perform various operations. The control unit 520 may include an electronic control unit (ECU).

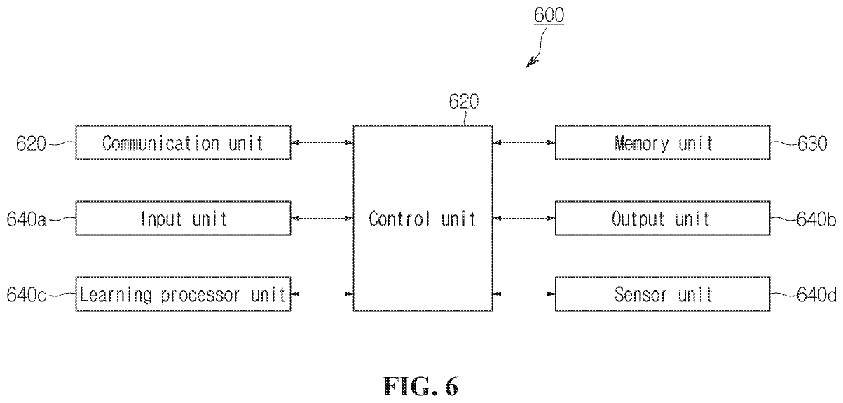

FIG. 6 is a diagram illustrating an example of an AI device applied to the present disclosure. For example, the AI device may be implemented as a fixed device or a movable device such as TV, projector, smartphone, PC, laptop, digital broadcasting terminal, tablet PC, wearable device, set-top box (STB), radio, washing machine, refrigerator, digital signage, robot, vehicle, etc.

Referring to FIG. 6, the AI device 600 may include a communication unit 610, a control unit 620, a memory unit 630, an input/output unit 640a/640b, a learning processor unit 640c and a sensor unit 640d. Blocks 610 to 630/640A to 640D may correspond to blocks 310 to 330/340 of FIG. 3, respectively.

The communication unit 610 may transmit and receive a wired and wireless signal (e.g., sensor information, user input, learning model, control signal, etc.) to and from external devices such as another AI device (e.g., 100x, 120, 140 in FIG. 1) or an AI server (140 in FIG. 1) using wired/wireless communication technology. To this end, the communication unit 610 may transmit information in the memory unit 630 to an external device or send a signal received from an external device to the memory unit 630.

The control unit 620 may determine at least one executable operation of the AI device 600 based on information determined or generated using a data analysis algorithm or machine learning algorithm. In addition, the control unit 620 may control the components of the AI device 600 to perform the determined operation. For example, the control unit 620 may request, search, receive, or utilize the data of the learning processor 640c or the memory unit 630, and control the components of the AI device 600 to perform predicted operation or operation determined to be preferred among at least one executable operation. In addition, the control unit 620 collects history information including a user's feedback on the operation content or operation of the AI device 600, and stores it in the memory unit 630 or the learning processor 640c or transmit it to an external device such as the AI server (140 in FIG. 1). The collected history information may be used to update a learning model.

The memory unit 630 may store data supporting various functions of the AI device 600. For example, the memory unit 630 may store data obtained from the input unit 640a, data obtained from the communication unit 610, output data of the learning processor unit 640c, and data obtained from the sensor unit 640. Also, the memory unit 630 may store control information and/or software code required for operation/execution of the control unit 620.

The input unit 640a may obtain various types of data from the outside of the AI device 600. For example, the input unit 620 may obtain learning data for model learning, input data to which the learning model is applied, etc. The input unit 640a may include a camera, a microphone and/or a user input unit, etc. The output unit 640b may generate audio, video or tactile output. The output unit 640b may include a display unit, a speaker and/or a haptic module. The sensor unit 640 may obtain at least one of internal information of the AI device 600, surrounding environment information of the AI device 600 or user information using various sensors. The sensor unit 640 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, and/or a radar.

The learning processor unit 640c may train a model composed of an artificial neural network using learning data. The learning processor unit 640c may perform AI processing together with the learning processor unit of the AI server (140 in FIG. 1). The learning processor unit 640c may process information received from an external device through the communication unit 610 and/or information stored in the memory unit 630. In addition, the output value of the learning processor unit 640c may be transmitted to an external device through the communication unit 610 and/or stored in the memory unit 630.

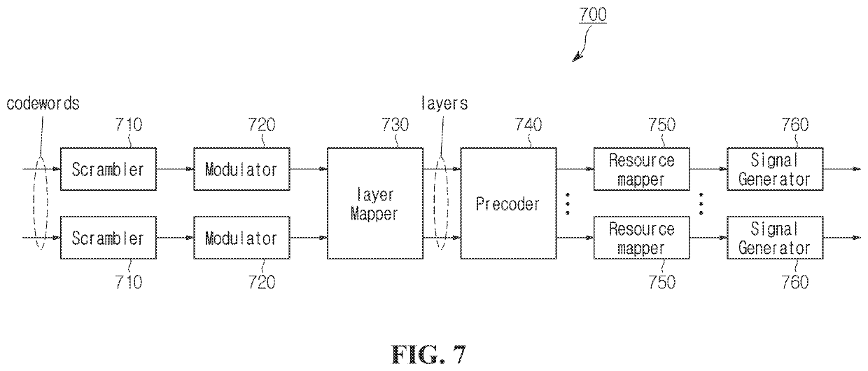

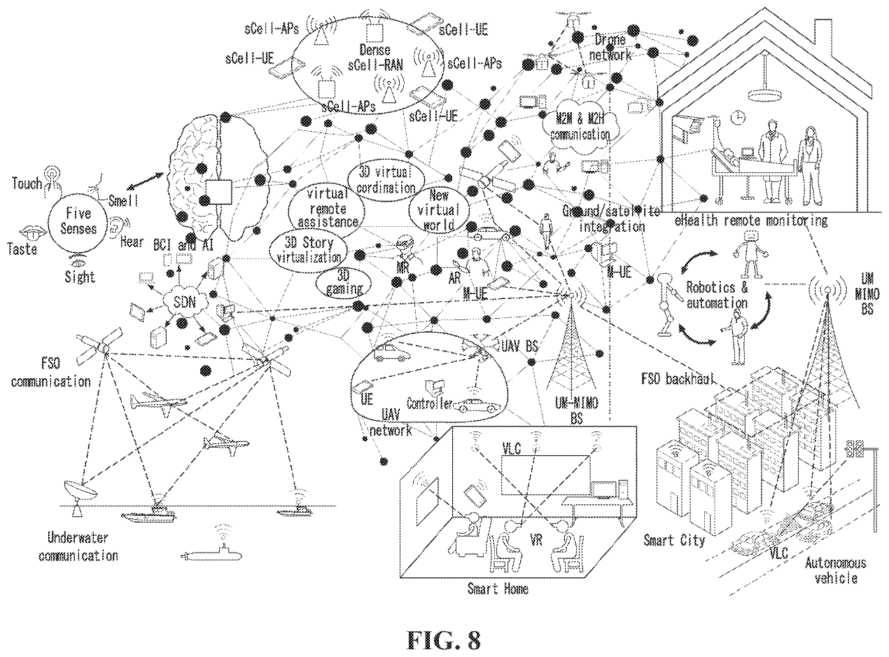

FIG. 7 illustrates a method of processing a transmitted signal applicable to the present disclosure. For example, the transmitted signal may be processed by a signal processing circuit. At this time, a signal processing circuit 700 may include a scrambler 710, a modulator 720, a layer mapper 730, a precoder 740, a resource mapper 750, and a signal generator 760. At this time, for example, the operation/function of FIG. 7 may be performed by the processors 202a and 202b and/or the transceiver 206a and 206b of FIG. 2. In addition, for example, the hardware element of FIG. 7 may be implemented in the processors 202a and 202b of FIG. 2 and/or the transceivers 206a and 206b of FIG. 2. For example, blocks 710 to 760 may be implemented in the processors 202a and 202b of FIG. 2. In addition, blocks 710 to 750 may be implemented in the processors 202a and 202b of FIG. 2 and a block 760 may be implemented in the transceivers 206a and 206b of FIG. 2, without being limited to the above-described embodiments.

A codeword may be converted into a radio signal through the signal processing circuit 700 of FIG. 7. Here, the codeword is a coded bit sequence of an information block. The information block may include a transport block (e.g., a UL-SCH transport block or a DL-SCH transport block). The radio signal may be transmitted through various physical channels (e.g., a PUSCH and a PDSCH). Specifically, the codeword may be converted into a bit sequence scrambled by the scrambler 710. The scramble sequence used for scramble is generated based in an initial value and the initial value may include ID information of a wireless device, etc. The scrambled bit sequence may be modulated into a modulated symbol sequence by the modulator 720. The modulation method may include pi/2-binary phase shift keying (pi/2-BPSK), m-phase shift keying (m-PSK), m-quadrature amplitude modulation (m-QAM), etc.

A complex modulation symbol sequence may be mapped to one or more transport layer by the layer mapper 730. Modulation symbols of each transport layer may be mapped to corresponding antenna port(s) by the precoder 740 (precoding). The output z of the precoder 740 may be obtained by multiplying the output y of the layer mapper 730 by an N*M precoding matrix W. Here, N may be the number of antenna ports and M may be the number of transport layers. Here, the precoder 740 may perform precoding after transform precoding (e.g., discrete Fourier transform (DFT)) for complex modulation symbols. In addition, the precoder 740 may perform precoding without performing transform precoding.

The resource mapper 750 may map modulation symbols of each antenna port to time-frequency resources. The time-frequency resources may include a plurality of symbols (e.g., a CP-OFDMA symbol and a DFT-s-OFDMA symbol) in the time domain and include a plurality of subcarriers in the frequency domain. The signal generator 760 may generate a radio signal from the mapped modulation symbols, and the generated radio signal may be transmitted to another device through each antenna. To this end, the signal generator 760 may include an inverse fast Fourier transform (IFFT) module, a cyclic prefix (CP) insertor, a digital-to-analog converter (DAC), a frequency uplink converter, etc.

A signal processing procedure for a received signal in the wireless device may be configured as the inverse of the signal processing procedures 710 to 760 of FIG. 7. For example, the wireless device (e.g., 200a or 200b of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 4 below. That is, Table 1 shows the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

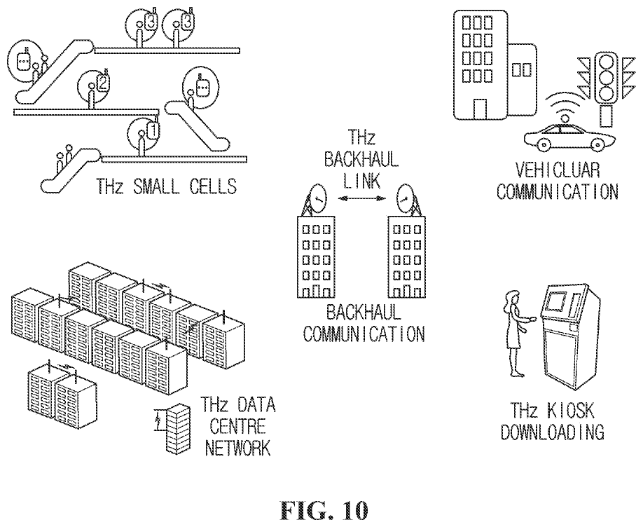

FIG. 10 illustrates an example of a communication structure providable in a 6G system applicable to the present disclosure.

Referring to FIG. 10, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system.

### Core Implementation Technology of 6G System

### Artificial Intelligence (AI)

The most important and newly introduced technology for the 6G system is AI. AI was not involved in the 4G system. 5G systems will support partial or very limited AI. However, the 6G system will support AI for full automation. Advances in machine learning will create more intelligent networks for real-time communication in 6G. Introducing AI in communication may simplify and enhance real-time data transmission. AI may use a number of analytics to determine how complex target tasks are performed. In other words, AI may increase efficiency and reduce processing delay.

Time consuming tasks such as handover, network selection, and resource scheduling may be performed instantly by using AI. AI may also play an important role in machine-to-machine, machine-to-human and human-to-machine communication. In addition, AI may be a rapid communication in a brain computer interface (BCI). AI-based communication systems may be supported by metamaterials, intelligent structures, intelligent networks, intelligent devices, intelligent cognitive radios, self-sustained wireless networks, and machine learning.

Recently, attempts have been made to integrate AI with wireless communication systems, but application layers, network layers, and in particular, deep learning have been focused on the field of wireless resource management and allocation. However, such research is gradually developing into the MAC layer and the physical layer, and in particular, attempts to combine deep learning with wireless transmission are appearing in the physical layer. AI-based physical layer transmission means applying a signal processing and communication mechanism based on an AI driver rather than a traditional communication framework in fundamental signal processing and communication mechanisms. For example, deep learning-based channel coding and decoding, deep learning-based signal estimation and detection, deep learning-based multiple input multiple output (MIMO) mechanism, and AI-based resource scheduling and allocation may be included.

Machine learning may be used for channel estimation and channel tracking, and may be used for power allocation, interference cancellation, and the like in a downlink (DL) physical layer. Machine learning may also be used for antenna selection, power control, symbol detection, and the like in a MIMO system.

However, the application of DNN for transmission in the physical layer may have the following problems.

Deep learning-based AI algorithms require a lot of training data to optimize training parameters. However, due to limitations in obtaining data in a specific channel environment as training data, a lot of training data is used offline. This is because static training on training data in a specific channel environment may cause a contradiction between diversity and dynamic characteristics of a radio channel.

In addition, current deep learning mainly targets real signals. However, the signals of the physical layer of wireless communication are complex signals. In order to match the characteristics of a wireless communication signal, additional research on a neural network that detects a complex domain signal is required.

Hereinafter, machine learning will be described in greater detail.

Machine learning refers to a series of operations for training a machine to create a machine capable of performing a task which can be performed or is difficult to be performed by a person. Machine learning requires data and a learning model. In machine learning, data learning methods may be largely classified into three types: supervised learning, unsupervised learning, and reinforcement learning.

Neural network learning is to minimize errors in output. Neural network learning is a process of updating the weight of each node in the neural network by repeatedly inputting learning data to a neural network, calculating the output of the neural network for the learning data and the error of the target, and backpropagating the error of the neural network from the output layer of the neural network to the input layer in a direction to reduce the error.

Supervised learning uses learning data labeled with correct answers in the learning data, and unsupervised learning may not have correct answers labeled with the learning data. That is, for example, learning data in the case of supervised learning related to data classification may be data in which each learning data is labeled with a category. Labeled learning data is input to the neural network, and an error may be calculated by comparing the output (category) of the neural network and the label of the learning data. The calculated error is backpropagated in a reverse direction (i.e., from the output layer to the input layer) in the neural network, and the connection weight of each node of each layer of the neural network may be updated according to backpropagation. The amount of change in the connection weight of each updated node may be determined according to a learning rate. The neural network's computation of input data and backpropagation of errors may constitute a learning cycle (epoch). The learning rate may be applied differently according to the number of iterations of the learning cycle of the neural network. For example, in the early stages of neural network learning, a high learning rate is used to allow the neural network to quickly achieve a certain level of performance to increase efficiency, and in the late stage of learning, a low learning rate may be used to increase accuracy.

A learning method may vary according to characteristics of data. For example, when the purpose is to accurately predict data transmitted from a transmitter in a communication system by a receiver, it is preferable to perform learning using supervised learning rather than unsupervised learning or reinforcement learning.

The learning model corresponds to the human brain, and although the most basic linear model may be considered, a paradigm of machine learning that uses a neural network structure with high complexity such as artificial neural networks as a learning model is referred to as deep learning.

The neural network cord used in the learning method is largely classified into deep neural networks (DNN), convolutional deep neural networks (CNN), and recurrent Boltzmann machine (RNN), and this learning model may be applied.

### Terahertz (THz) Communication

THz communication is applicable to the 6G system. For example, a data rate may increase by increasing bandwidth. This may be performed by using sub-THz communication with wide bandwidth and applying advanced massive MIMO technology.

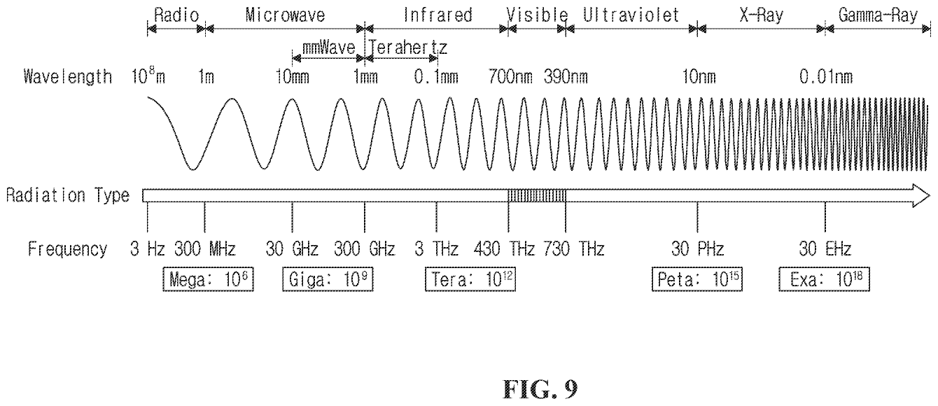

FIG. 9 illustrates an electromagnetic spectrum applicable to the present disclosure. For example, referring to FIG. 9, THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF.

The main characteristics of THz communication include (i) bandwidth widely available to support a very high data rate and (ii) high path loss occurring at a high frequency (a high directional antenna is indispensable). A narrow beam width generated by the high directional antenna reduces interference. The small wavelength of a THz signal allows a larger number of antenna elements to be integrated with a device and BS operating in this band. Therefore, an advanced adaptive arrangement technology capable of overcoming a range limitation may be used.

### THz Wireless Communication

FIG. 10 illustrates a THz communication method applicable to the present disclosure.

Referring to FIG. 10, THz wireless communication uses a THz wave having a frequency of approximately 0.1 to 10 THz (1 THz=1012 Hz), and may mean terahertz (THz) band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays and has a shorter wavelength than the RF/millimeter wave and thus high straightness and is capable of beam convergence.

### Artificial Intelligence System

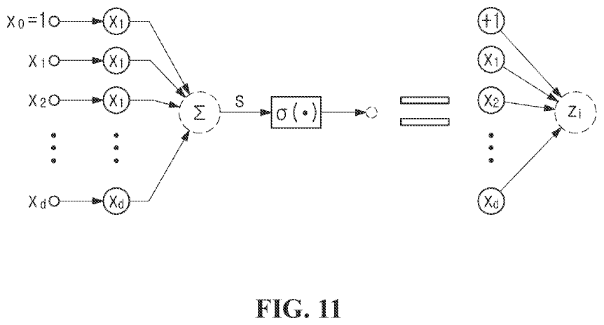

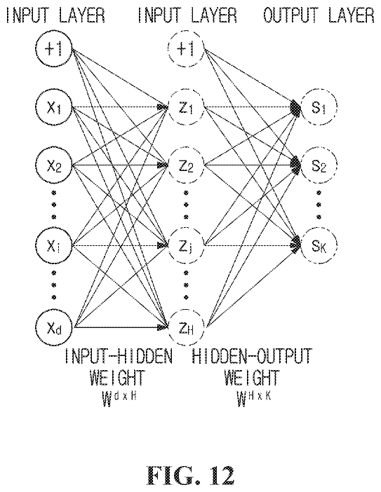

FIG. 11 illustrates a perceptron architecture in an artificial neural network applicable to the present disclosure. In addition, FIG. 12 illustrates an artificial neural network architecture applicable to the present disclosure.

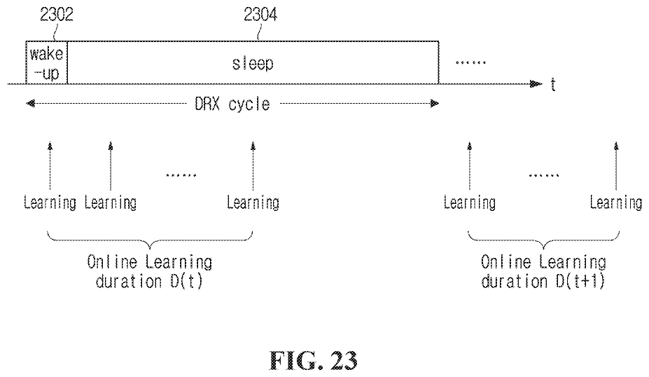

As described above, an artificial intelligence system may be applied to a 6G system. Herein, as an example, the artificial intelligence system may operate based on a learning model corresponding to the human brain, as described above. Herein, a paradigm of machine learning, which uses a neural network architecture with high complexity like artificial neural network, may be referred to as deep learning. In addition, neural network cores, which are used as a learning scheme, are mainly a deep neural network (DNN), a convolutional deep neural network (CNN), and a recurrent neural network (RNN). Herein, as an example referring to FIG. 23, an artificial neural network may consist of a plurality of perceptrons. Herein, when an input vector x={x₁, x₂, . . . , x_{d}} is input, each component is multiplied by a weight {W₁, W₂, . . . , W_{d}}, results are all added up, and then an activation function of) is applied, of which the overall process may be referred to as a perceptron. For a large artificial neural network architecture, when expanding the simplified perceptron structure illustrated in FIG. 11, an input may be applied to different multidimensional perceptrons. For convenience of explanation, an input value or an output value will be referred to as a node.

Meanwhile, the perceptron structure illustrated in FIG. 11 may be described to consist of a total of 3 layers based on an input value and an output value. An artificial neural network, which has H (d+1)-dimensional perceptrons between a 1st layer and a 2nd layer and K (H+1)-dimensional perceptrons between the 2nd layer and a 3rd layer, may be expressed as in FIG. 12.

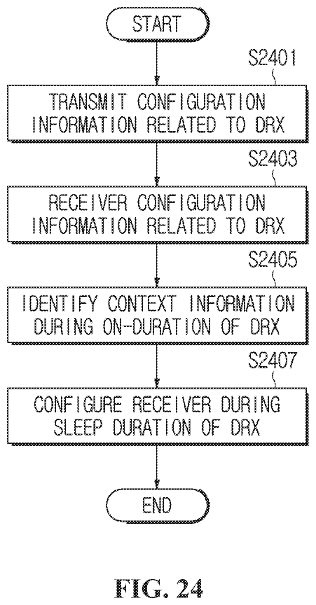

Herein, a layer, in which an input vector is located, is referred to as an input layer, a layer, in which a final output value is located, is referred to as an output layer, and all the layers between the input layer and the output layer are referred to as hidden layers. As an example, 3 layers are disclosed in FIG. 24, but since an input layer is excluding in counting the number of actual artificial neural network layers, it can be understood that the artificial neural network illustrated in FIG. 12 has a total of 2 layers. An artificial neural network is constructed by connecting perceptrons of a basic block two-dimensionally.

The above-described input layer, hidden layer and output layer are commonly applicable not only to multilayer perceptrons but also to various artificial neural network architectures like CNN and RNN, which will be described below. As there are more hidden layers, an artificial neural network becomes deeper, and a machine learning paradigm using a sufficiently deep artificial neural network as a learning model may be referred to as deep learning. In addition, an artificial neural network used for deep learning may be referred to as a deep neural network (DNN).

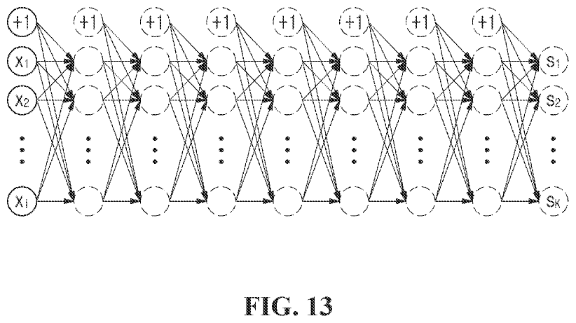

FIG. 13 illustrates a deep neural network applicable to the present disclosure.

Referring to FIG. 13, a deep neural network may be a multilayer perceptron consisting of 8 layers (hidden layers+output layer). Herein, the multilayer perceptron structure may be expressed as a fully-connected neural network. In a fully-connected neural network, there may be no connection between nodes in a same layer and only nodes located in neighboring layers may be connected with each other. A DNN has a fully-connected neural network structure combining a plurality of hidden layers and activation functions so that it may be effectively applied for identifying a correlation characteristic between an input and an output. Herein, the correlation characteristic may mean a joint probability between the input and the output.

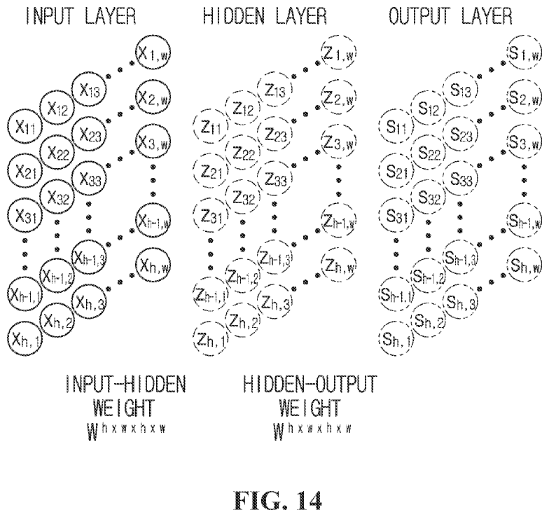

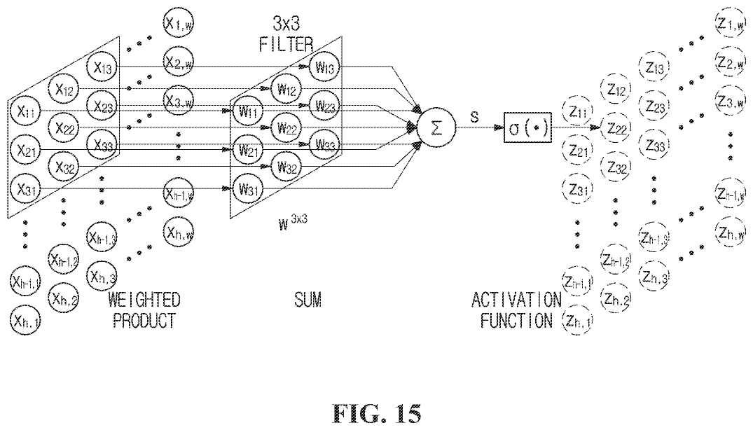

FIG. 14 illustrates a convolutional neural network applicable to the present disclosure. In addition, FIG. 15 illustrates a filter operation of a convolutional neural network applicable to the present disclosure.

As an example, depending on how to connect a plurality of perceptrons, it is possible to form various artificial neural network structures different from the above-described DNN. Herein, in the DNN, nodes located in a single layer are arranged in a one-dimensional vertical direction. However, referring to FIG. 14, it is possible to assume a two-dimensional array of w horizontal nodes and h vertical nodes (the convolutional neural network structures of FIG. 14). In this case, since a weight is applied to each connection in a process of connecting one input node to a hidden layer, a total of h×w weights should be considered. As there are h×w nodes in an input layer, a total of h²w² weights may be needed between two neighboring layers.

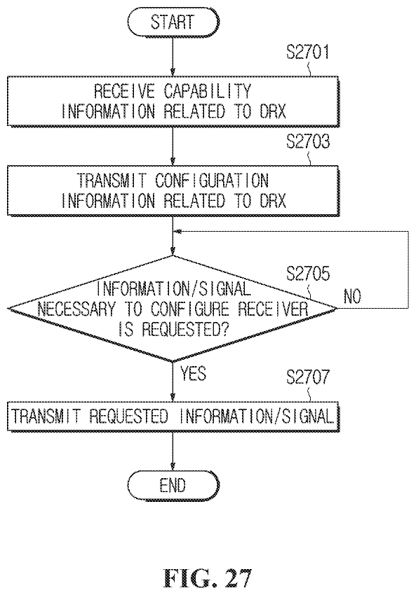

Furthermore, as the convolutional neural network of FIG. 14 has the problem of exponential increase in the number of weights according to the number of connections, the presence of a small filter may be assumed instead of considering every mode of connections between neighboring layers. As an example, as shown in FIG. 27, weighted summation and activation function operation may be enabled for a portion overlapped by a filter.

At this time, one filter has a weight corresponding to a number as large as its size, and learning of a weight may be performed to extract and output a specific feature on an image as a factor. In FIG. 15, a 3×3 filter may be applied to a top rightmost 3×3 area of an input layer, and an output value, which is a result of the weighted summation and activation function operation for a corresponding node, may be stored at z₂₂.

Herein, as the above-described filter scans the input layer while moving at a predetermined interval horizontally and vertically, a corresponding output value may be put a position of a current filter. Since a computation method is similar to a convolution computation for an image in the field of computer vision, such a structure of deep neural network may be referred to as a convolutional neural network (CNN), and a hidden layer created as a result of convolution computation may be referred to as a convolutional layer. In addition, a neural network with a plurality of convolutional layers may be referred to as a deep convolutional neural network (DCNN).

In addition, at a node in which a current filter is located in a convolutional layer, a weighted sum is calculated by including only a node in an area covered by the filter and thus the number of weights may be reduced. Accordingly, one filter may be so used as to focus on a feature of a local area. Thus, a CNN may be effectively applied to image data processing for which a physical distance in a two-dimensional area is a crucial criterion of determination. Meanwhile, a CNN may apply a plurality of filters immediately before a convolutional layer and create a plurality of output results through a convolution computation of each filter.

Meanwhile, depending on data properties, there may be data of which a sequence feature is important. A recurrent neural network structure may be a structure obtained by applying a scheme, in which elements in a data sequence are input one by one at each timestep by considering the distance variability and order of such sequence datasets and an output vector (hidden vector) output at a specific timestep is input with a very next element in the sequence, to an artificial neural network.

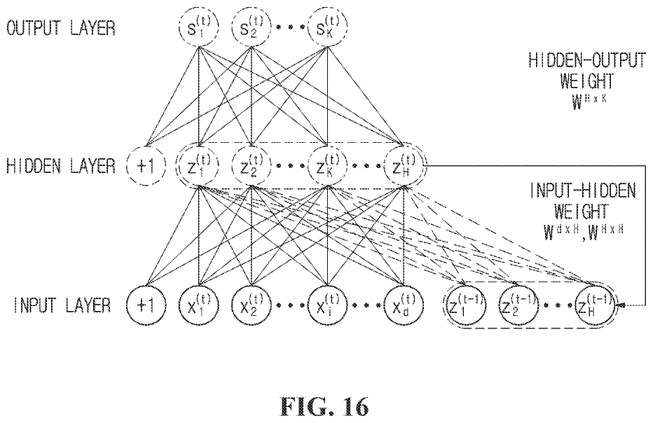

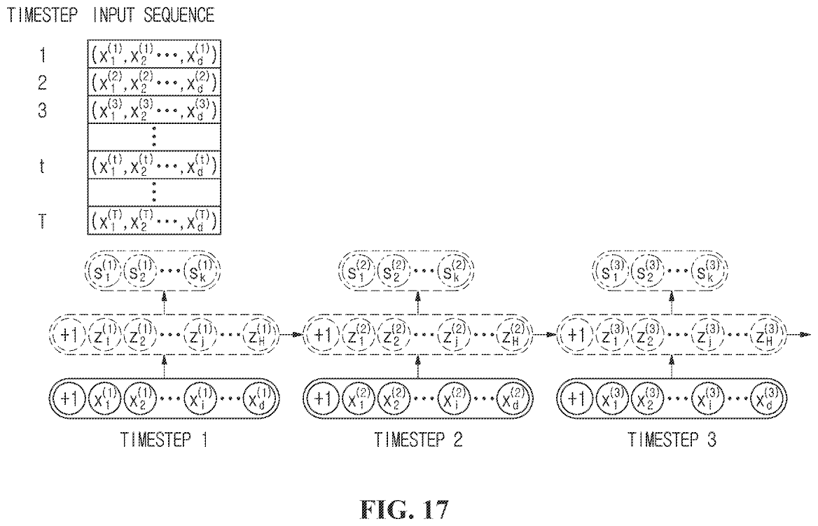

FIG. 16 illustrates a neural network architecture with a recurrent loop applicable to the present disclosure. FIG. 17 illustrates an operational structure of a recurrent neural network applicable to the present disclosure.

Referring to FIG. 16, a recurrent neural network (RNN) may have a structure which applies a weighted sum and an activation function by inputting hidden vectors {z₁^{(t-1)}, z₂^{(t-1)} . . . , z_{H}^{(t-1)}} of an immediately previous timestep t−1 during a process of inputting elements {x₁^{(t)}, x₂^{(t)}, . . . , x_{d}^{(t)}} of a timestep t in a data sequence into a fully connected neural network. The reason why such hidden vectors are forwarded to a next timestep is because information in input vectors at previous timesteps is considered to have been accumulated in a hidden vector of a current timestep.

In addition, referring to FIG. 17, a recurrent neural network may operate in a predetermined timestep order for an input data sequence. Herein, as a hidden vector {z₁⁽¹⁾, z₂⁽¹⁾, . . . , z_{H}⁽¹⁾} at a time of inputting an input vector {x₁^{(t)}, x₂^{(t)}, . . . , x_{d}^{(t)}} of timestep 1 into a recurrent neural network is input together with an input vector {x₁⁽²⁾, x₂⁽²⁾, . . . , x_{d}⁽²⁾} of timestep 2, a vector {z₁⁽²⁾, z₂⁽²⁾, . . . , z_{H}⁽²⁾} of a hidden layer is determined through a weighted sum and an activation function. Such a process is iteratively performed at timestep 2, timestep 3 and until timestep T.

Meanwhile, when a plurality of hidden layers are allocated in a recurrent neural network, this is referred to as a deep recurrent neural network (DRNN). A recurrent neural network is so designed as to effectively apply to sequence data (e.g., natural language processing).

Apart from DNN, CNN and RNN, other neural network cores used as a learning scheme include various deep learning techniques like restricted Boltzmann machine (RBM), deep belief networks (DBN) and deep Q-Network, and these may be applied to such areas as computer vision, voice recognition, natural language processing, and voice/signal processing.

Recently, there are attempts to integrate AI with a wireless communication system, but these are concentrated in an application layer and a network layer and, especially in the case of deep learning, in a wireless resource management and allocation filed. Nevertheless, such a study gradually evolves to an MAC layer and a physical layer, and there are attempts to combine deep learning and wireless transmission especially in a physical layer. As for a fundamental signal processing and communication mechanism, AI-based physical layer transmission means application of a signal processing and communication mechanism based on an AI driver, instead of a traditional communication framework. For example, it may include deep learning-based channel coding and decoding, deep learning-based signal estimation and detection, deep learning-based MIMO mechanism, and AI-based resource scheduling and allocation.

### Specific Embodiments of the Present Disclosure

The present disclosure is directed to performing learning for a receiver model in a wireless communication system and relates to a technology for performing online learning. Hereinafter, the present disclosure will describe various embodiments for supporting and performing online learning. Specifically, the present disclosure proposes an online learning technique of a physical layer receiver configured as a machine learning model or a deep learning model.

A wireless communication system may provide voice, data and other various types of communication services. With the recent dramatic advance of artificial intelligence (AI) technology, the number of attempts to combine AI technology with communication systems is surging. Combination with AI technology may be classified mainly into communications for AI (C4AI), which develops communication technology to support AI, and AI for communications (AI4C) that utilizes AI technology to improve communication performance. In the case of AI4C, there is an attempt to enhance design efficiency by replacing a channel encoder/decoder by an end-to-end auto-encoder. In the case of C4AI, among distributed learning techniques, a federated learning technique is used to share only a weight or gradient of a model with a server without sharing raw data of a device, and thus a common prediction model may be updated while personal information is protected. In addition, one method has been proposed to distribute the loads of a device, a network edge, and a cloud server by using a split inference technique.

The present disclosure handles an online learning problem using a reference signal in a wireless communication system that delivers an end-to-end message by using a transmitter and a receiver that are configured as machine learning models. Herein, a machine learning model may include a neural network model. A neural network-based wireless communication system uses the feature that a neural network approximates an arbitrary function or a non-linear function well. In a situation where a message passes a wireless channel in a transmission neural network and then is received into a reception neural network, good transmission/reception performance may be obtained by using the above-described feature of a neural network well. However, in order to obtain good performance, learning of a neural network is required during actual operation. Every complex wireless channel may be covered by increasing the complexity of a model used in a terminal, but an increase of complexity will increase the burden of implementation. A model used in a terminal should be designed with an adequate degree of complexity. Meanwhile, when a terminal is moving, channel environment keeps changing over time, and thus there is a high probability that a neural network of a terminal cannot sufficiently reflect a channel feature. Accordingly, online learning is required.

Operation states allowed for a terminal include a connected state, in which data can be transmitted or received, and an idle state in which data is not transmitted or received and power consumption is minimized. When a terminal operates in idle state, it is difficult for the terminal to perform online learning during a sleep operation. In idle state, a terminal wakes up from a sleep state at a discontinuous reception (DRX) cycle and checks a paging message arrived to it or measures a neighbor cell. Specifically, by activating a receiver at a DRX cycle, a terminal may enter a wake-up state and attempt data reception or perform measurement. Accordingly, only during a wake-up duration, the terminal may receive a reference signal and perform online learning. However, if the terminal moves significantly during a sleep state, since there is a great change of channel, there may be a problem in that online learning may not be efficiently performed due to late update. Furthermore, the terminal may be one of various types of devices including an IoT device and a high-end smartphone. As there are various types of devices, there may be various neural network models. In such a situation, when online learning is performed by replacing a neural network model for a receiver of each terminal through a network, there will be a problem in that complexity increase seriously.

To solve the above-described problems, the present disclosure proposes a technology that uses a generative neural network to easily learn various channel propagation environments of sub-6 GHz communication, mmWave communication, and THz communication, effectively performs online learning, and also minimizes power consumption.

According to the proposed technology, during an idle-state operation, even if a receiver of a physical layer enters a sleep mode, online learning for a physical layer neural network may be performed based on channel data generated by a channel generative network during a sleep duration. In addition, the proposed technology may not perform unnecessary learning in sleep mode by evaluating uncertainty of channel generation data and performing active learning based on uncertainty.

As one type of machine learning, active learning is a technique that is performed while labeling for data for learning is performed based on interaction with a user. On the other hand, passive learning may be understood as supervised learning that uses already labeled learning data.

(x,y)∈D~p(D) [Equation 1]

In Equation 1, x means data, y means a label, D means a data set, and p (D) means a distribution of data sets.

In the case of passive learning, a label y for x may be added to a data set D, and samples x and y may all be given in advance in the training data set D following a distribution p(D). In the case of active learning, x is efficiently sampled in the distribution p (D) during training, and after a label y is queried to a user, the training is performed based on training data to which the queried label is added. Herein, a labeling task in active learning is referred to as annotation. When x is given in active learning, an entity, which gives information on a label y, may be referred to as ‘user’, ‘oracle’, ‘annotator’ and the like.

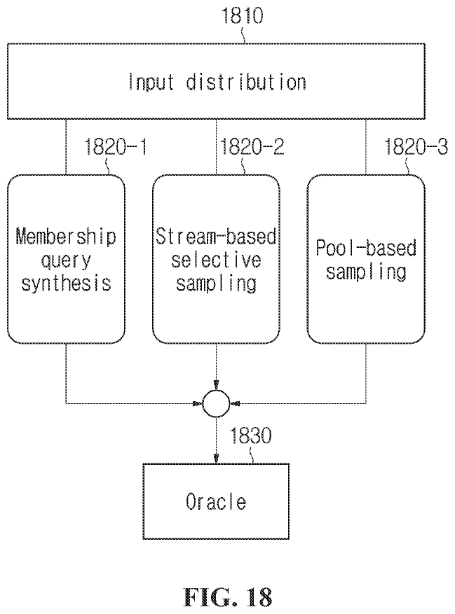

FIG. 18 illustrates sampling methods for active learning according to an embodiment of the present disclosure. FIG. 18 exemplifies three representative methods of active learning. The three methods are related to an operation of sampling data x in an input distribution 1810. Herein, the input distribution 1810 may be referred to as instance space. In membership query synthesis 1820-1, for learning, a model synthesizes a sample x belonging to the input distribution 1810 and requests a label y for the sample x to an oracle. That is, the model synthesizes the sample x and queries an oracle 1830. In stream-based selective sampling 1820-2, data x successively extracted from the input distribution 1810 are selectively distinguished, and a label y for the distinguished data x is requested to the oracle 1830. In pool-based sampling 1820-3, data x obtained from the input distribution 1810 are all included in a pool, a most advantageous sample for learning is selected in the pool, and a label y for the selected sample is requested to the oracle 1830. Thus, as a model actively participates in a data collection process, the number of samples required for training may be reduced, and performance may also be improved.

In other words, active learning may be used to reduce cost for acquiring training data. In machine learning based on data, acquiring data requires a lot of costs. If active learning is used to save such a large cost, learning ability may be improved even with a small amount of data. In addition, active learning may improve learning speed and performance.

Active sampling in active learning may be classified into two main types, that is, uncertainty sampling and diversity sampling. Uncertainty sampling is a method of enhancing effectiveness by learning most ambiguous data first, and diversity sampling is a method of learning an overall distribution quickly by sampling representative data evenly from the overall data distribution.

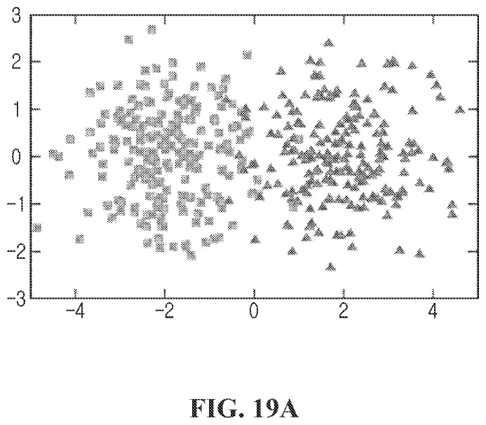

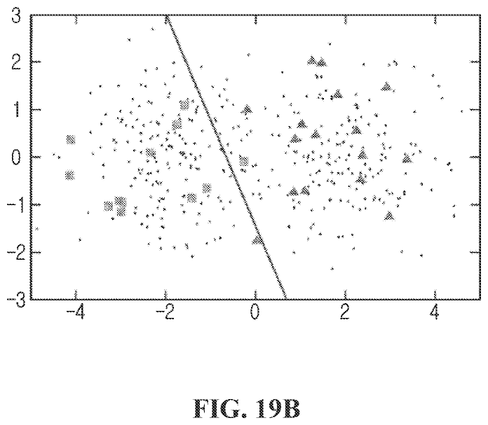

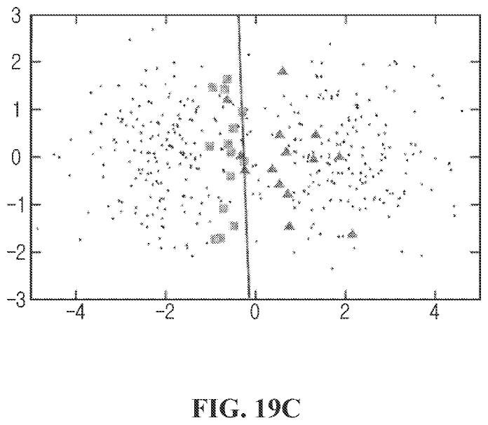

The effect of uncertainty sampling may be seen from an example of a simple binary classification task, and the binary classification task may be exemplified as in FIG. 19A to FIG. 19C. FIG. 19A to FIG. 19C illustrate examples of results of active learning and passive learning according to an embodiment of the present disclosure. FIG. 19A exemplifies an overall distribution of data sampling. As shown in FIG. 19A, learning starts after overall data are acquired by pool-based learning. FIG. 19B exemplifies a result of passive learning. As random sampling is performed, input values are evenly selected from the overall distribution so that the boundary is inaccurately learned. FIG. 19C exemplifies a result of active learning that performs sampling around regions with high uncertainty near the boundary. Referring to FIG. 19C, even when a small amount of samples are used, a good result is formed. Active learning may be applied to a regression task as well as the classification task exemplified in FIG. 19A to FIG. 19C.

The effect of active learning on uncertainty sampling has been theoretically proven by some analyzable cases. In comparison with passive learning, it is known that active learning can reduce the number of samples required for training down to a logarithmic complexity level. When an ideal case is assumed and a simple binary classifier is considered, if sampling of active learning is applied based on not full search but binary search, the reduction of complexity down to the logarithmic complexity level is expected to be achieved easily. As a more specific example, when a learning problem is considered for data that are evenly sampled from a unit spherical plane in a d-dimensional space, if a homogeneous linear separator is applied, passive learning may have a sample complexity of

$$O ( \frac{d}{ε} ) ,$$

while active learning of a query-by-committee method that makes a decision based on results of multiple models may receive data with a complexity of

$$O ( \frac{d}{ε} )$$

and then perform labeling learning for data with a complexity of

$$O ( d log ( \frac{1}{ε} ) ) .$$

Here, ε is a value representing error performance of a learning model.

In the present disclosure, a Bayesian model capable of quantifying uncertainty may be used to evaluate uncertainty for a sample of a model. Herein, a parameter Φ of a model, which is evaluated for the uncertainty of a transceiver model, is not a deterministic value but a probability variable. The learning of a Bayesian model is directed to finding a posterior probability for data, as shown in Equation 2 below.

$$p ( ϕ \vert D ) = \frac{p ( y \vert x , ϕ ) p ( ϕ )}{\int p ( y \vert x , ϕ ) p ( ϕ ) d ϕ} \qquad [ Equation 2 ]$$

In Equation 2, Φ means a model parameter, D means a training data set, p(Φ|D) means a prior distribution of model parameter including prior information for a model, x means data, y means an output of the model, p(y|x, Φ) means a probability of y under a condition that x and Φ are given, and p(Φ) means a prior distribution of Φ. In Equation 2, the denominator is a probability of training data, is referred to as evidence and is equal to p (D).

A predicted probability distribution p(y′|x′,D) for new data x′ may be calculated by a model conditional probability, a posterior probability of Φ and marginalization of the model conditional probability.

p(y′(x′,D)=∫p(y′|x′,φ)p(φ|D)dφ [Equation 3]

In Equation 3, y′ means an output of a new model, x′ means new data, D means a training data set, and p(y|) means a probability distribution of output when training data is given.

When a predicted probability distribution is acquired, an average and a variation may be determined by using the predicted probability distribution. As the parameter ¢ of a model is a probability variable, the uncertainty of the model is reflected. In addition, when Equation 3 is used, a variation of prediction may be determined. The variation may be used to evaluate uncertainty.

For a posterior probability of Φ during training, except a linear model, closed form derivation is very difficult, and various methods for solving the problem are being proposed. Especially, an approximation method and sampling-based methods may be applied to obtaining posterior probabilities.

An acquisition function for estimating uncertainty may also be obtained by applying a Bayesian assumption. For example, an acquisition function may be obtained by reflecting a prior distribution of model in many possible acquisition functions and then integrating them. In this case, the acquisition function ƒ_{acq}(x) is a functional that implies a Bayesian prediction distribution p(y|x,θ). Herein, as exemplified in Equation 4, an acquisition function may be a functional that performs marginalization of a prior distribution on a function. For example, the Shannon entropy may be used. In this case, uncertainty may be evaluated based on maximum entropy of a model estimate value of a given reference signal.

H(y|x,Dₜᵣₐᵢₙ)=−Σp(y=k|x,Dₜᵣₐᵢₙ)log p(y=k|x,Dₜᵣₐᵢₙ) [Equation 4]

In Equation 4, x means an input of a model, Dtrain means training data, y means an output of the model, and H(y|x,Dtrain) means entropy of y under the condition that x and Dtrain are given.

According to another embodiment, as shown in Equation 5 below, uncertainty may be evaluated based on a prediction of a model and an amount of mutual information of a model Φ.

I(y|x,φ,Dₜᵣₐᵢₙ)=H(y|x,Dₜᵣₐᵢₙ)=E_{p(φ|D}_{ₜᵣₐᵢₙ}₎{H(y|x,φ)} [Equation 5]

In Equation 5, y means an output of a model, x means an input of the model, Φ means a model parameter, Dtrain means training data, I(y|x,φ,Dtrain) means an amount of mutual information when the input of the model is given, and Ep(Φ|Dtrain){H(y|x, Φ)} means an average of entropy for a model posterior distribution.

According to another embodiment, as shown in Equation 6 below, uncertainty may be evaluated based on a variation ratio of a model output.

variationᵣₐₜᵢₒ=1−max p(y/x,Dₜᵣₐᵢₙ) [Equation 6]

In Equation 6, variationᵣₐₜᵢₒ means a variation ratio, x means an input of a model, Dtrain means training data, y means an output of the model, and max p(y|x,Dtrain) means a maximum value of a conditional probability for an output variable when the probability variable input x is given.

According to another embodiment, an acquisition function may determine a variation or a standard deviation for estimation from a Bayesian prediction distribution and estimate uncertainty based on the determined variation or standard deviation.

In various embodiments of the present disclosure, a generative network, which outputs channel data for online learning, may be used. The generative network is a neural network, which models a probability distribution, and may generate an output sample by combining features obtained from training data for input values that are sampled according to a specific probability distribution. In various embodiments of the present disclosure, a terminal may have a generative network for generating a channel and acquire a latent probability distribution of the terminal from a base station or another terminal to acquire a latent vector value.

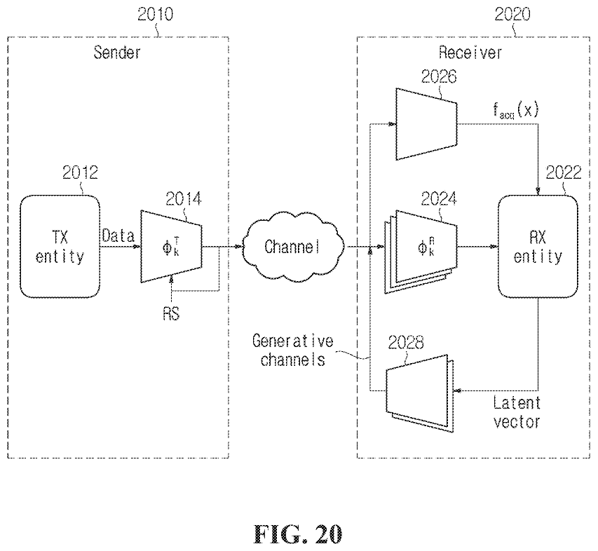

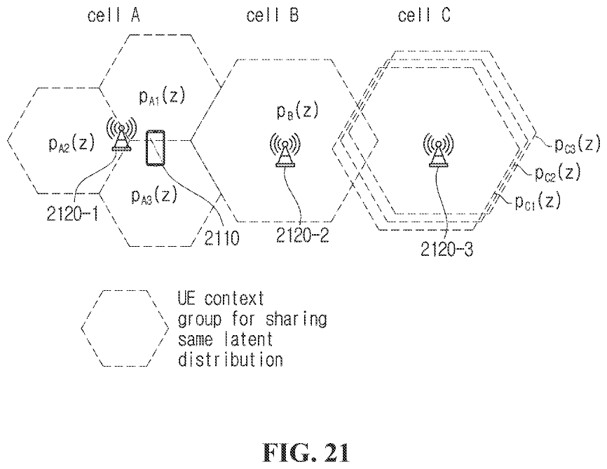

FIG. 20 illustrates functional structures of devices supporting active learning according to an embodiment of the present disclosure. FIG. 20 exemplifies a transmission/reception model in which, of two devices 2010 and 2020 performing communication according to an embodiment, the first device 2010 functions as a transmitter, and the second device 2020 functions as a receiver. In downlink communication, the first device 2010 and the second device 2020 may be understood as a base station and a UE respectively. In uplink communication, the first device 2010 and the second device 2020 may be understood as a UE and a base station respectively.

Referring to FIG. 20, the first device 2010 includes a transmit entity 2012 and a transmitter model 2014. The transmit entity 2012 performs overall control and processing for data transmission. For example, the transmit entity 2012 may generate transmission data and provide necessary information for an operation of the transmitter model 2014. The transmitter model 2014 is a data processing block implemented as a neural network. The transmitter model 2014 generates a signal that includes at least one of data and a reference signal.

The second device 2020 includes a receive entity 2022, a receiver model 2024, an evaluation unit 2026, and a channel generation unit 2028. The receive entity 2022 performs overall control and processing for data reception. For example, the transmit entity 2012 may process information output from the receiver model 2024, control a learning procedure based on uncertainty information output from the evaluation unit 2026, and provide a latent vector for generating channel data to the channel generation unit 2028. In addition, although not illustrated in FIG. 20, the receive entity 2022 may be configured to generate feedback information or control information necessary for online learning and to transmit the feedback information or the control information to the first device 2010.

The receiver model 2024 is a data processing block implemented as a neural network. The receiver model 2022 may include at least one neural network for performing at least one task related to a reference signal. Accordingly, the receiver model 2024 may selectively receive any one of a plurality of tasks by using reference signals received from the first device 2010. For example, the receiver model 2024 may include deep neural networks (DNNs) for channel tasks. Each task has an index k, and the receiver model 2024 may include a plurality of neural networks that have a model parameter

$${ϕ}_{k}^{R} ( k = 0 , 1 , … , N ) .$$

The model parameter φ means a parameter intrinsic to a model or a pre-learned meta parameter.

$${ϕ}_{k}^{T}$$

is a parameter of a transmitter neural network model and may serve as a type of precoding for the active learning reference signal k and a data transmission signal.

$${ϕ}_{k}^{R}$$

is a parameter of a receiver neural network. A receiver knows the active learning reference signal transmitted by a transmitter.

$${ϕ}_{k}^{T} and {ϕ}_{k}^{R}$$

may be trained by performing a stochastic gradient decent method to achieve optimization

$${arg max}_{{ϕ}_{k}^{T} , {ϕ}_{k}^{R}} L ( {D}_{RS} , {ϕ}_{k}^{T} , {ϕ}_{k}^{R} )$$

of a joint loss function of the transmitter and the receiver by using an existing active learning reference signal data set DRS. Specifically, while the transmitter

$${ϕ}_{k}^{T}$$

is fixed, a reference signal may be transmitter, and training may be performed by using the stochastic gradient decent method for

$${ϕ}_{k}^{R} ,$$

and then while the receiver

$${ϕ}_{k}^{R}$$

is fixed again, a procedure of training the transmitter

$${ϕ}_{k}^{T}$$

may be performed. This procedure may be repeatedly performed. In case the transmitter is trained, a loss may be delivered from the receiver to the transmitter. Herein, a device including the receiver may know

$${ϕ}_{k}^{T} .$$

The evaluation unit 2026 evaluates a signal received from the first device 2010. An evaluation result may include information indicating uncertainty that is used for uncertainty sampling. For example, the evaluation unit 2026 may include a DNN for uncertainty measurement. The evaluation unit 2026 may generate a result of an acquisition function facq(x) and provide the result to the receive entity 2022.

facq(x) is an acquisition function for evaluating uncertainty and evaluates data obtained from a generative network channel based on a transmitter model and a receiver model. facq(x) may use both the transmitter model

$${ϕ}_{k}^{T}$$

and the receiver model

$${ϕ}_{k}^{R} .$$

In the example of FIG. 20, facq(x) is included in the second device 2020 that operates as a receiver, but the first device 2010 operating as a transmitter may also include facq(x). Like a procedure of training a transmitter and a receiver, while

$${ϕ}_{k}^{T}$$

is fixed, an acquisition value contributed by

$${ϕ}_{k}^{R}$$

may be determined, and while

$${ϕ}_{k}^{R}$$

is fixed, an acquisition value contributed by

$${ϕ}_{k}^{T}$$

may be determined, and this repetitive procedure may determine acquisition values in turn. Especially, when an acquisition value contributed by

$${ϕ}_{k}^{T}$$

is determined, the second device 2020 operating as a receiver may obtain the acquisition value contributed by

$${ϕ}_{k}^{T}$$

from the first device 2010. An output of evaluation may include a probability distribution or a probability value.

The channel generation unit 2028 generates channel data. The channel generation unit 2028 may receive a latent vector representing a feature of a channel from the receive entity 2022 and generate channel data as learning data for training of the receiver model 2024 based on the latent vector. The latent vector is used as an input into a channel generative network constituting the channel generation unit 2028 and represents a probability distribution of a channel to be generated. Channel data may include at least one of channel information based on a latent vector (e.g., channel matrix, doppler value, power value, etc.), reference signals passing a channel specified by channel information, or a reference signal pattern. For example, the channel generation unit 2028 may include a common channel generative DNN.

The transmission/reception model of FIG. 20 includes a model parameter

$${ϕ}_{k}^{T}$$

of a transmitter and a model parameter

$${ϕ}_{k}^{R}$$

of a receiver for a task k. Herein, k is an index indicating one of N channel-related tasks, and a channel discriminative neural network (e.g., the receiver model 2024) may be as many as N channel-related tasks. The model

$${ϕ}_{k}^{T}$$

of a transmitter and the model

$${ϕ}_{k}^{R}$$

of a receiver, which correspond to the channel-related reference signal type index k, may be understood models that perform a task k. k is defined as many as the number of reference signal types operated by a transmitter and a receiver, and all of them are a single signal processing task. For example, in the case of a CSI-RS of 5G NR, at least three tasks may be defined such as a beam tracking CSI-RS, a CSI-RS for link state evaluation, and a CSI-RS for timing synchronization.

A channel generative neural network included in the channel generation unit 2028 may include M neural networks that are always less than or equal to the number of channel discriminative neural networks (e.g., the receiver model 2024). Although there are many tasks using a channel discriminative neural network, channels have one ultimate feature. Accordingly, it is possible to train a discriminative neural network (e.g., a receiver model) online by using a channel generative neural network that is common to all terminals. The channel generative neural network may have a value z of a latent vector as an input and generate, as an output, a training data channel necessary for a channel discriminative neural network. The value z of the latent vector may be acquired by being sampled from a probability distribution that corresponds to a context of a terminal. A probability distribution p(z) may be treated as a terminal (UE) context latent distribution.

A terminal context may be understood as a set of all factors affecting a channel. For example, factors, which determine a context, may include at least one of location information of a terminal, an acceleration of the terminal, velocity information of the terminal, posture information including an angular velocity of the terminal and an angular acceleration of the terminal, a moving state of an external object, a shape of an antenna, or sensing data (e.g., information obtained through sound and vision sensors). The above-described factors may be expressed by a quantified vector. Numerous terminal contexts may be derived by various combinations of factors. A system according to various embodiments may define terminal contexts as a limited number of terminal context groups. A terminal context group may be defined as a region capable of sharing a latent distribution p(z) and be referred to as ‘UE context group’. Examples of terminal context groups are as shown in FIG. 21.

FIG. 21 illustrates examples of regions distinguished according to a latent distribution according to an embodiment of the present disclosure. FIG. 21 exemplifies a situation in which at least one terminal context group is allocated to a geographical area. Referring to FIG. 21, a first device 2120-1 provides a cell A, a second device 2120-2 provides a cell B, a third device 2120-3 provides a cell C, and a UE 2110 is located in the cell A. Three terminal context groups with latent distributions pA1(z), pA2(z) and pA3(z) respectively may be allocated to three areas included in the cell A respectively. In addition, one terminal context group with a latent distribution pB(z) may be allocated to the cell B. In addition, three terminal context groups with latent distributions pC1(z), pC2(z) and pC3(z) respectively may be allocated to the overall area of the cell C. In other words, in the cell C, terminal context groups may be allocated in three overlapping areas. As a specific example, in a same terrain, terminal context groups for three classifications according to a moving velocity of a terminal may be allocated, or terminal context groups for three classifications according to an angular velocity distribution may be allocated. For convenience of understanding, FIG. 21 exemplifies a base station and a terminal, but a terminal context group may also be applied to a sidelink for terminal-to-terminal communication.

The example of FIG. 21 shows a combination of moving properties between a specific region or a region and a terminal. A simplest example of region-based allocation of a terminal context group is discrimination of a cell or a smaller area in a terrain with a similar propagation characteristic based on location information. Areas with different latent distributions may be determined by dividing a propagation environment, which affects a reference signal task in a mmWave or THz band, and may become a criterion for applying an AI model. Unlike the propagation characteristic of a low frequency band, a signal of a mmWave or THz band has greater straightness. Accordingly, in an environment of mmWave or THz bands, a high frequency propagation path distribution specified by reflection, diffraction and refraction may have a large number of cases according to moving objects, arrangement of antennas and the movement of a terminal as well as static buildings and terrains. A geographical distribution, in which a terminal is located, and a dynamic state of the terminal have the greatest impact in determining a latent distribution for the terminal. This means that a latent distribution p(z) according to a terminal context may be associated with a regional distribution.

When a terminal is turned on, the terminal may search for a cell and perform communication with a base station. Herein, when network registration is completed, the terminal is operated in idle mode. A duration of operating in idle mode may be divided into a wake-up duration and a sleep duration. The wake-up duration and the sleep duration are distributed according to a setting of a discontinuous reception (DRX) cycle. Herein, according to various embodiments, a monitoring operation for a context of the terminal may be performed based on the DRX cycle.

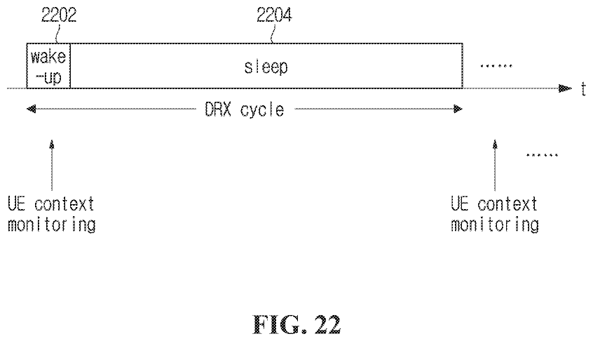

FIG. 22 illustrates examples of timesteps at which context monitoring is performed during a discontinuous reception (DRX) cycle according to an embodiment of the present disclosure. Referring to FIG. 22, one DRX cycle includes a wake-up duration 2202 and a sleep duration 2204. Herein, the wake-up duration may be referred to as an on-duration. Herein, terminal context monitoring may be performed for the wake-up duration 2202. For the wake-up duration 2202 that occur repeatedly according to a DRX cycle, a terminal may determine whether a terminal context is changed by a movement of the terminal and a change of an external environment. If a changed terminal context does not satisfy a latent distribution p(z) for sampling a current channel, the terminal may update the latent distribution through signaling of a base station or another terminal.

According to an embodiment, the necessity of updating p(z) according to a change of terminal context may be determined by an uncertainty measurement network (e.g., evaluation unit 2026). When a probability of not satisfying the current environment p(z) exceeds a specific threshold Qₜₕᵣₑₛₕ, in other words, if uncertainty evaluated based on a signal actually passing a channel in the wake-up duration 2202 exceeds the threshold Qₜₕᵣₑₛₕ, an operation for updating p(z) may be performed. It is because, although a terminal context changes due to a change of environment, uncertainty increase if p(z) not satisfying the changed terminal context is used. Herein, the threshold Qₜₕᵣₑₛₕ may be configured by a network. Based on an uncertainty measurement result and the threshold Qₜₕᵣₑₛₕ, active learning may be performed. The threshold Qₜₕᵣₑₛₕ may include an out-of-distribution threshold and an in-distribution threshold.

For the sleep duration, every component in a terminal corresponding to a physical layer may be deactivated (e.g., turned off). Accordingly, because no reference signal is received during the sleep duration, a discriminative neural network (e.g., the receiver model 2024) requiring online learning may be trained by using an output of a channel generative neural network (e.g., the channel generation unit 2028). An example of online learning during a sleep duration is as shown in FIG. 23 below.

FIG. 23 illustrates examples of timesteps at which online learning is performed during a DRX cycle according to an embodiment of the present disclosure. Referring to FIG. 23, one DRX cycle includes a wake-up duration 2302 and a sleep duration 2304. Like in FIG. 23, online learning in idle mode may be performed during an online learning period D(t). D(t) is always shorter than or equal to a DRX period. The length of D(t) may be determined by an uncertainty measurement network (e.g., the evaluation unit 2026). For example, when uncertainty increases, more learning is required, and thus the length of D(t) may increase along with an increase of uncertainty. A receiver may adaptively determine D(t) so that uncertainty does not exceed Qₜₕᵣₑₛₕ. In order to D(t), during the wake-up duration 2302, an output of an uncertainty neural network (e.g., the evaluation unit 2026) may be determined not based on a signal generated from a generative network (e.g., the channel generation unit 2028) but based on reference signals received through an actual channel. The channel generative neural network (e.g., the channel generation unit 2028) may be trained by offline learning or federated learning between another terminal and a base station.

FIG. 24 illustrates an example of a procedure of configuring a receiver during a DRX mode operation according to an embodiment of the present disclosure. FIG. 24 exemplifies a method for operating a UE, and operations exemplified herein may be understood as operations of the second device 2020 of FIG. 20.

Referring to FIG. 24, at step S2401, a UE transmits capability information related to DRX. For example, the capability information related to DRX may include at least one of whether a DRX operation is supported, information related to a DRX cycle (e.g., an inactivity timer, a long cycle length, a short cycle length, a short cycle timer, etc.), or a DRX-related parameter preferred by the UE. According to an embodiment, for example, the capability information related to DRX may include at least one of information indicating whether online learning may be performed during a DRX operation, information indicating whether channel data may be generated, or information indicating at least one supportable terminal context item. In addition to the capability information related to DRX, the UE may further transmit another type of capability information, for example, at least one of information related to a supportable radio access technology (RAT), information related to a duplex scheme, information related to a parameter used in a layer, or information related to an operation mode/state. According to an embodiment, the capability information related to DRX may be transmitted in response to an enquiry of a base station.

At step S2403, the UE receives configuration information related to DRX. The configuration information related to DRX includes control information necessary for a DRX operation. For example, the configuration information related to DRX may include at least one of a length of each duration within a DRX cycle, a timer value related to a DRX operation, a DRX cycle length, or a HARQ-related parameter. In addition, the configuration information related to DRX may include information indicating a DRX operation. According to an embodiment, the configuration may include information instructing to perform online learning during the DRX operation and a function supportable for online learning (e.g., provision of latent distribution information, transmission of a reference signal for online learning, uncertainty sampling for a reference signal, etc.).

At step S2405, the UE identifies context information during an on-duration of the DRX cycle. The UE may activate physical layer hardware during the on-duration, acquire at least one of a signal, measurement information and sensing information received from a base station, or determine a context based on the acquired information. According to an embodiment, the UE may identify location information and identify context information corresponding to the location information.

At step S2407, the UE configures a receiver during the sleep duration of the DRX cycle. According to an embodiment, the receiver may include at least one neural network model. In this case, the UE may perform training for a neural network during the sleep duration. Specifically, the UB may generate channel data corresponding to the context information and perform training for at least one neural network model based on the generated channel data. That is, the UE may perform training for at least one neural network model by using the generated channel data as learning data. Herein, according to an embodiment, for active learning, uncertainty sampling may be performed. Accordingly, the UE may perform online learning for a neural network model constituting a receiver, while reducing power consumption by deactivating at least one physical layer hardware.

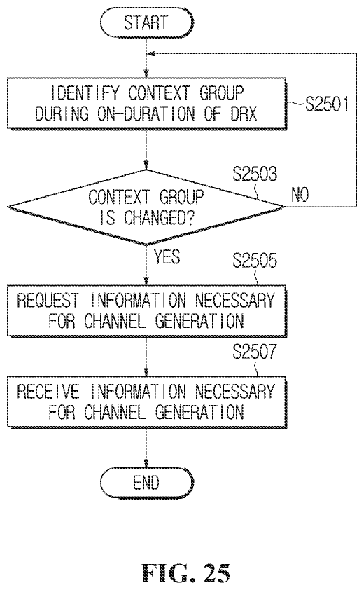

FIG. 25 illustrates an example of a procedure of responding to a change of context information according to an embodiment of the present disclosure. FIG. 25 exemplifies a method for operating a UE, and operations exemplified herein may be understood as operations of the second device 2020 of FIG. 20.

Referring to FIG. 25, at step S2501, a UE identifies a context group during an on-duration of a DRX cycle. The UE may activate physical layer hardware during the on-duration, acquire at least one of a signal, measurement information and sensing information received from a base station, and determine a context group based on the acquired information. To this end, although not illustrated in FIG. 25, the UE may receive information related to a condition for selecting each context group. In this case, the UE may identify a context group of the UE by identifying which condition is satisfied by the acquired condition. For example, the UE may identify a condition satisfied by acquired information among conditions of each of at least one or more context groups and identify a context group corresponding to the identified condition. According to an embodiment, the UE may identify location information and identify context information corresponding to the location information.

At step S2503, the UE determines whether a context group is changed. That is, the UE compares a context group applied for generating current channel data and the context group identified at step S2501. In other words, the UE checks whether the context group identified at step S2501 is different from a context group that is applied for generating current channel data.

If a context is changed, at step S2505, the UE requests information necessary for channel generation. In other words, the UE transmits information necessary for generating channel data, that is, probability distribution information related to a channel corresponding to an identified context group. For example, the probability distribution information may include a latent distribution. To this end, the UB may suspend the DRX operation at least temporarily. According to an embodiment, the UE may perform this step when the UE does not hold probability distribution information regarding a changed context group.

At step S2507, the UE receives information necessary for channel generation. In other words, the UE receives a message including information necessary for generating channel information, that is, probability distribution information related to a channel corresponding to an identified context group. For example, the probability distribution information may include a latent distribution. Accordingly, the UE may generate channel data corresponding to a changed context group.

In the embodiment described with reference to FIG. 25, a UE identifies a current context group and determines whether a context group is changed. According to another embodiment, after determining a change of a context group, a UE may identify a changed context group. There may be a situation in which a change of a context group is identified but a changed context group is not identified. For example, a UE may determine uncertainty of a receiver model based on a signal, which has passed a channel, and determine a change of a context group, if uncertainty exceeds a threshold. In this case, the UE may not be able to identify a changed context group. Accordingly, additionally, the UE may collect information for identifying the changed context group (e.g., a signal passing a channel, measurement information, sensing information, etc.) and identify the changed context group.

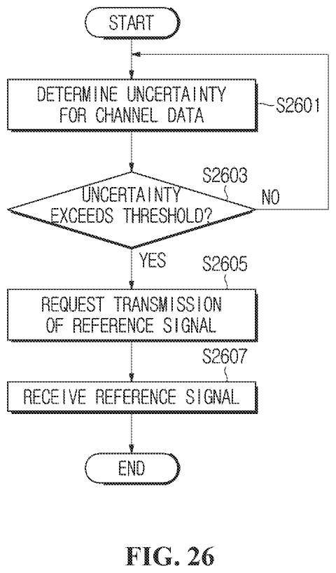

FIG. 26 illustrates an example of a procedure of responding to an increase of uncertainty according to an embodiment of the present disclosure. FIG. 26 exemplifies a method for operating a UE, and operations exemplified herein may be understood as operations of the second device 2020 of FIG. 20.

Referring to FIG. 26, at step S2601, a UE determines uncertainty for channel data. The UE may determine uncertainty for channel data generated by a channel generative model by using an acquisition function. Uncertainty may be determined based on channel data, a receiver model, and the like. Herein, uncertainty means a degree of reliability of an output when a task is performed for channel data by using a receiver model.

At step S2603, the UE checks whether uncertainty exceeds a threshold. In other words, the UE compares uncertainty and the threshold. Herein, the threshold may be configured beforehand by a base station. According to an embodiment, the threshold may be provided as one of parameters included in configuration information related to a DRX operation.

If uncertainty exceeds the threshold, at step S2605, the UE requests transmission of a reference signal. That is, the UE transmits a message for requesting transmission of a reference signal. Herein, the message may include at least one of information related to a context group of the UE, information related to a channel generative model, and information related to a reference signal pattern.

At step S2607, the UE receives at least one reference signal. To this end, the UE may receive configuration information (e.g., a resource location) of at least one reference signal from a base station and measure the at least one reference signal. According to an embodiment, at least one reference signal may be transmitted according to a reference signal pattern indicated by the UE. Accordingly, the UE may perform training for a receiver model and a channel generative model by using reference signals that have passed an actual channel.

As described with reference to FIG. 26, when uncertainty exceeds a threshold, transmission of a reference signal may be requested. In addition, when uncertainty is smaller than another threshold, suspension of the transmission of the reference signal may be requested. That is, if uncertainty is lowered by training that uses reference signals that have passed an actual channel, a UE may transmit a message for requesting suspension of transmission of a reference signal. Then, if additional training is needed, the UE may perform training by using channel data generated by a channel generative model.

FIG. 27 illustrates an example of a procedure of supporting online learning according to an embodiment of the present disclosure. FIG. 27 exemplifies a method for operating a base station, and operations exemplified herein may be understood as operations of the first device 2010 of FIG. 20.

Referring to FIG. 27, at step S2701, a base station receives capability information related to DRX. For example, the capability information related to DRX may include at least one of whether a DRX operation is supported, information related to a DRX cycle (e.g., an inactivity timer, a long cycle length, a short cycle length, a short cycle timer, etc.), or a DRX-related parameter preferred by a UE. According to an embodiment, for example, the capability information related to DRX may include at least one of information indicating whether online learning may be performed during a DRX operation, information indicating whether channel data may be generated, or information indicating at least one supportable terminal context item. In addition to the capability information related to DRX, the UE may further transmit another type of capability information, for example, at least one of information related to a supportable radio access technology (RAT), information related to a duplex scheme, information related to a parameter used in a layer, or information related to an operation state. According to an embodiment, the base station may transmit a message for requesting capability information to the UE and receive the capability information as a response.

At step S2703, the base station transmits configuration information related to DRX. The configuration information related to DRX includes control information necessary for a DRX operation. For example, the configuration information related to DRX may include at least one of a length of each duration within a DRX cycle, a timer value related to a DRX operation, a DRX cycle length, and a HARQ-related parameter. In addition, the configuration information related to DRX may include information indicating a DRX operation. According to an embodiment, the configuration may include information instructing to perform online learning during the DRX operation and a function supportable for online learning (e.g., provision of latent distribution information, transmission of a reference signal for online learning, uncertainty sampling for a reference signal, etc.).

At step S2705, the base station checks whether information or a signal necessary for configuring a receiver is requested. That is, the base station checks whether information or a signal necessary for training of a receiver model included in a receiver of the UE is requested from the UE. Request for information or a signal is performed through a message, and the message may include at least one of information on a context group of the UE, information related to a task of the receiver model to be trained, and information related to uncertainty.

When the information or signal necessary for the receiver is requested, at step S2707, the base station transmits the requested information or signal. That is, in response to the request of the UE, the base station may transmit a message or a signal including information necessary for training. For example, the signal may include at least one reference signal.

The embodiments described with reference to FIG. 24 to FIG. 27 may be implemented for training of a receiver model of a UE for downlink communication. To support a task for an uplink channel, a receiver model of a base station for uplink communication may also be trained through a similar procedure. In this case, since the base station has a receiver model and the UE has a transmitter model, the base station may generate channel data and train the receiver model by using the generated channel data. In addition, when necessary, the base station may request the UE to transmit an uplink reference signal.

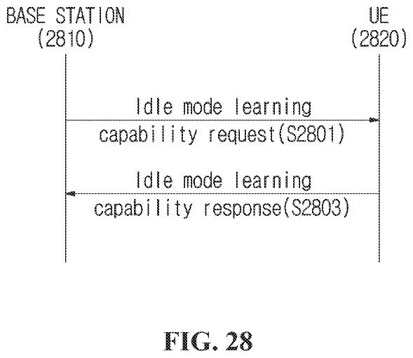

FIG. 28 illustrates an example of a procedure of exchanging capability information related to online learning according to an embodiment of the present disclosure. FIG. 28 exemplifies signaling for checking whether learning of idle mode is supported between a base station 2810 and a UE 2820

Referring to FIG. 28, at step S2801, the base station 2810 transmits an idle mode learning capability request message to the UE 2820. The idle mode learning capability request message may be referred to as a capability enquiry message.

At step S2803, the UE 2820 transmits an idle mode learning capability response message to the base station 2810. Thus, the base station 2810 may acquire information for supporting idle mode learning of the UE 2820. The idle mode learning capability response message may be referred to as a UE capability message. For example, the idle mode learning capability response message may include at least one of items listed in Table 2 below.

TABLE 2

| Information | |
|---|---|
| element | Description |
| Support of | A model set or an identifier of the set that a UE may |
| generative | support in a common generative model set capable of |
| model set | supporting idle state learning. |
| UE context | Supportable terminal context information (e.g., location |
| capability | information, angular velocity and velocity information, |
| | posture information including angular velocity and |
| | angular acceleration, a moving state of an external object, |
| | a shape of a transmission/reception antenna, and |
| | information obtained using sound and vision sensors) |

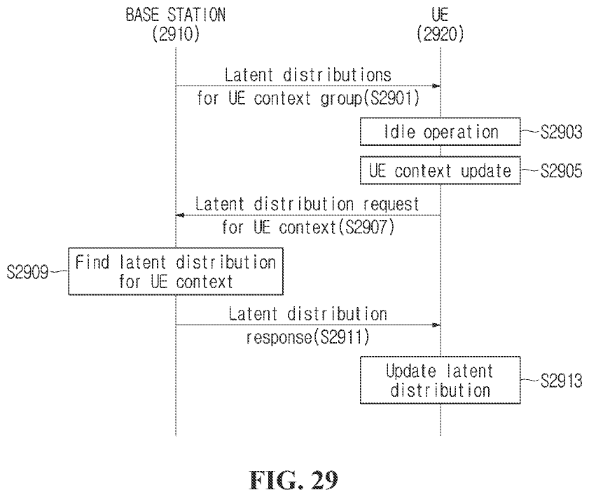

FIG. 29 illustrates an example of a procedure of updating latent distribution information according to an embodiment of the present disclosure. FIG. 29 exemplifies signaling for updating a latent distribution according to a change of context between a base station 2910 and a UE 2920.

Referring FIG. 29, at step S2901, the base station 2910 transmits information related to a latent distribution for a UE context group to the UE 2920. For example, the information related to the latent distribution for the UE context group may include information defining a mapping relationship between the context group and the latent distribution. Herein, the context group may be specified as a set of factors affecting a channel.

At step S2903, the UE 2920 performs an idle operation. Specifically, the UE 2920 operates a wake-up duration and a sleep duration according to a DRX cycle. Herein, according to various embodiments, the UE 2920 may perform context monitoring during the wake-up duration and perform online learning by using a channel generative network during at least a part of the sleep duration.

At step S2905, the UE 2920 updates the UE context. The UE 2920 may update the UE context based on a result of the context monitoring during the wake-up duration. Specifically, the UE 2920 may acquire at least one of a signal received from the base station 2910, measurement information, sensing information, and hardware information and determine a context based on the acquired information.

At step S2907, the UE 2920 transmits a latent distribution request for the UE context to the base station 2910. In other words, the UE 2920 notifies a changed context or a context group corresponding to the changed context and requests information related to a latent distribution necessary to generate channel data corresponding to the changed context or the context group. According to an embodiment, the UE 2920 may terminate the DRX operation and transmit a request for the latent distribution. According to another embodiment, the UE 2920 may temporarily terminate the DRX operation and transmit the request for the latent distribution. According to another embodiment, the UE 2920 may transmit the request for the latent distribution while maintaining the DRX operation.

At step S2909, the base station 2910 finds the latent distribution for the UE context. That is, the base station 2910 searches for the latent distribution for the changed context or the context group in response to the request of the UE 2920. For example, the base station 2910 may search for the latent distribution corresponding to the context received from the UE 2920 in a table defining a mapping relationship between a context and a latent distribution.

At step S2911, the base station 2910 transmits a latent distribution response to the UE 2920. That is, the base station 2910 transmits information related to a latent distribution corresponding to the changed context of the UE 2920. According to an embodiment, the base station 2910 may transmit information related to the latent distribution as a part of configuration information related to DRX.

At step S2913, the UE 2920 updates a latent distribution. The UE 2920 replaces an existing latent distribution by a latent distribution corresponding to the changed context. Accordingly, the UE 2920 may generate channel data according to the changed context.

The example procedure described with reference to FIG. 29 may be performed when it is confirmed by measurement that a context of a UE is changed. Information on a context group according to a context for training in idle state, which is transmitted at step S2901, may be provided to a UE by using broadcasting, multicasting or dedicated signaling. Herein, latent distribution information may be delivered beforehand by using at least one of items as shown in Table 3 below.

TABLE 3

| Information element | Description |
|---|---|
| UE context group ID | Context group identifier |
| UE context condition | Condition for being included in a context group |
| Generative model ID | Channel generative model for idle state learning |
| | or identifier related to the model |
| Latent distribution ID | Channel generative latent distribution for idle |
| | state learning or identifier related to the |
| | distribution |
| Uncertainty threshold | Threshold for uncertainty, including |
| | Qₒᵤₜ_{_{—}}ₜₕᵣₑₛₕ(out-of-distribution) and |
| | Qᵢₙ_{_{—}}ₜₕᵣₑₛₕ(in-distribution) |

A UE receives information related to a latent distribution and identifies a context group corresponding to its context. While performing an idle state operation, the UE may perform online learning by using a channel generative network and minimize terminal power consumption simultaneously. Herein, the UE may adaptively adjust an online learning duration so that uncertainty is not smaller than a threshold.

When a context of a terminal is changed but latent distribution information, which is delivered beforehand, does not include information on a context group corresponding to the changed context, a UE may transmit a latent distribution request like in step S2907. Herein, the latent distribution request may include at least one of items as shown in Table 4 below.

TABLE 4

| Information element | Description |
|---|---|
| UE context group ID | Current context group identifier |
| UE context | Updated context |

A base station may deliver per-group latent distribution information updated based on information as shown in Table 4 to a UE.

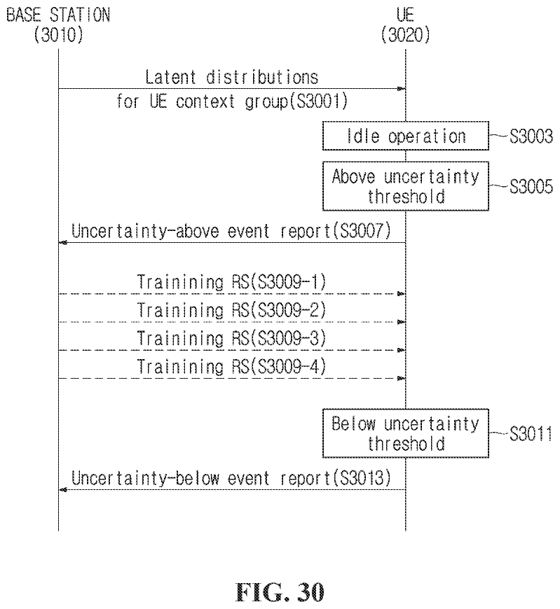

FIG. 30 illustrates an example of a procedure of controlling uncertainty of a receiver model according to an embodiment of the present disclosure. FIG. 30 exemplifies signaling between a base station 3010 and a UE 3020 for performing training based on uncertainty.

Referring to FIG. 30, at step S3001, the base station 3010 transmits information related to a latent distribution for a UE context group to the UE 3020. For example, the information related to the latent distribution for the UE context group may include information defining a mapping relationship between the context group and the latent distribution. Herein, the context group may be specified as a set of factors affecting a channel.

At step S3003, the UE 3020 performs an idle operation. Specifically, the UE 3020 operates a wake-up duration and a sleep duration according to a DRX cycle. Herein, according to various embodiments, the UE 3020 may perform context monitoring during the wake-up duration and perform online learning by using a channel generative network during at least a part of the sleep duration.

At step S3005, the UE 3020 determines that uncertainty exceeds a threshold. Specifically, the UE 3020 determines uncertainty by using an acquisition function and compares uncertainty and the threshold. At step S3007, the UE 3020 transmits, to the base station 3010, a report notifying the occurrence of an event that uncertainty exceeds the threshold.

At step S3009-1 to step S3009-4, the base station 3010 transmits reference signals for training. The reference signals may be used to train a receiver model of the UE 3020. According to an embodiment, reference signals are samples for active learning and may follow at least one pattern selected by uncertainty sampling.

At step S3100, the UE 3020 determines that uncertainty is smaller than the threshold. Specifically, the UE 3020 determines uncertainty by using an acquisition function and compares uncertainty and the threshold. At step S3013, the UE 3020 transmits a report notifying the occurrence of an event that uncertainty is smaller than the threshold.

The example procedure described with reference to FIG. 30 may be performed for online training for a channel generative network and a channel discriminative network when uncertainty exceeds a threshold although a context of a UE is not changed. The UE may receive latent distribution information from a base station and perform an idle state operation. The UE measures uncertainty, detects that the measured uncertainty exceeds a threshold Q_{out_thresh}, and reports the event to a base station. The base station transmits reference signals related to a channel task in response to the event. Based on one transmission of the reference signals, a channel generative neural network and every discriminative neural network related to a channel task may be trained. As training is performed, uncertainty becomes smaller than Qin thresh, and the UE transmits a report about such an event to the base station. The report may include at least one of items as shown in Table 5 below.

TABLE 5

| Information element | Description |
|---|---|
| UE context group ID | Current context group identifier |
| UE context | Updated context |
| Channel generative | Parameter of updated channel |
| model | generative model |

According to the above-described various embodiments, online learning may be performed during a DRX operation. The above-described embodiments are described by assuming a DRX operation. However, various embodiments may also be performed during a DRX operation in a connected state, that is, during a connected-DRX (C-DRX) operation.

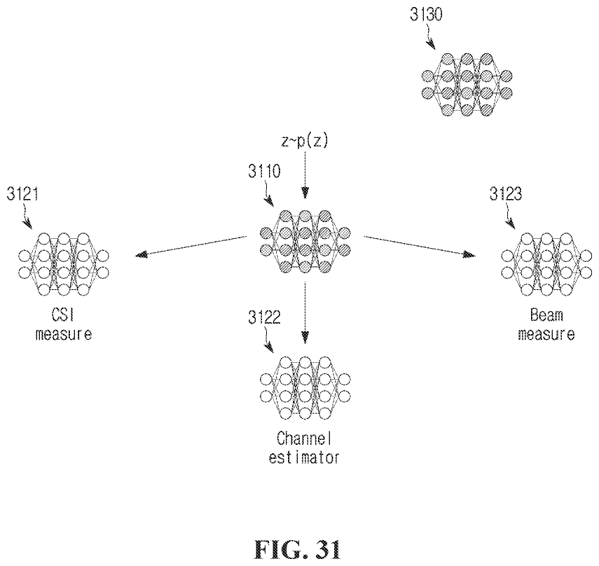

Hereinafter, the present disclosure will describe a specific scenario of performing online learning by using the proposed technology. According to an embodiment, channel-related tasks of a terminal may be classified into measurement of channel state information (CSI) such as a rank indicator (RI), a channel quality indicator (CQI) and a precoding matrix indicator (PMI), a channel estimator, and beam measurement. Discriminative neural networks corresponding to tasks may be as shown in FIG. 31 below.

FIG. 31 illustrates examples of various neural networks for different tasks according to an embodiment of the present disclosure. Referring to FIG. 31, a channel generative network 3110 is commonly shared by a plurality of receiver models 3121 to 3123 in a terminal. The channel generative network 3110 may provide training samples for three tasks corresponding to the plurality of receiver models 3121 to 3123. An input of the channel generative network 3110 is a sample z sampled in a latent distribution p(z) according to a terminal context. An uncertainty neural network 3130 measures uncertainty for online training samples and the three receiver models 3121 to 3123.

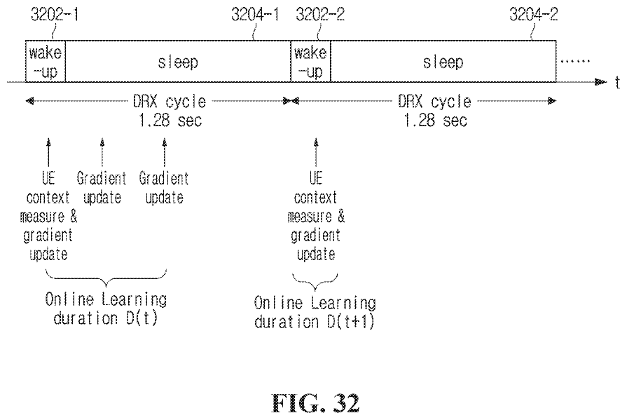

FIG. 32 illustrates examples of timesteps at which context measurement and online learning are performed during a DRX cycle according to an embodiment of the present disclosure. In an example of FIG. 32, a DRX cycle has a length of 1.28 seconds. Referring to FIG. 32, monitoring is periodically performed for a terminal context during wake-up durations 3202-1 and 3202-2. If the context is changed, a latent distribution is updated through proposed signaling. In addition, online learning is performed during sleep durations 3204-1 and 3204-2.

In case there are three tasks, a terminal evaluates uncertainty for the given three tasks and determines lengths of online learning durations D(t) and D(t+1) based on uncertainty. For example, if an uncertainty threshold Q_{out_thresh} delivered through signaling is designated as 10%, an online learning duration with an appropriate length may be determined so that uncertainty does not exceed 10%.

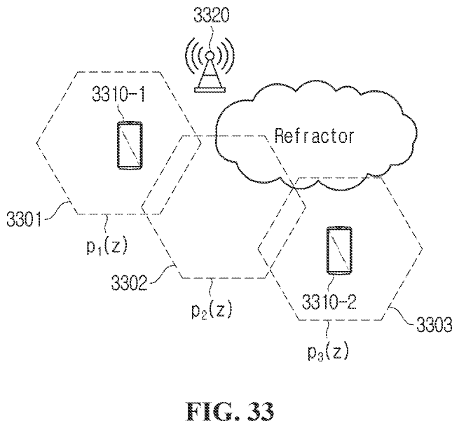

FIG. 33 illustrates examples of context groups according to an embodiment of the present disclosure. FIG. 33 exemplifies three different terminal context groups. Referring to FIG. 33, three areas 3301 to 3303 with latent distributions p1(z), p2(z) and p3(z) are context groups that are generated due to different propagation features. A context group allocated to the first area 3301 has a line-of-sight (LOS) environment between a base station 3320 and a terminal 3310-1, the third area 3303 is a channel area by diffraction and reflection, and the second area 3302 is an area with a probability of both features of the first area 3301 and the third area 3303. When the terminal 3310-1 moves from the third area 3303 to the second area 3302, the terminal 3310-2 determines a context change and receives a new latent distribution p2(z) from the base station 3320 through signaling according to the above-described embodiment.

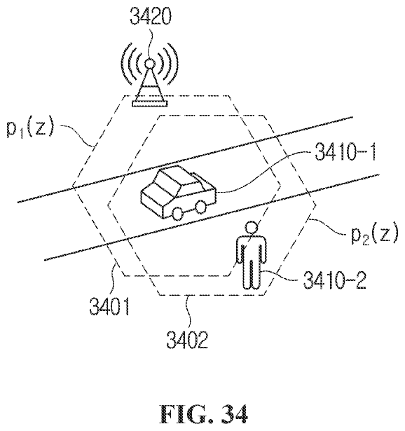

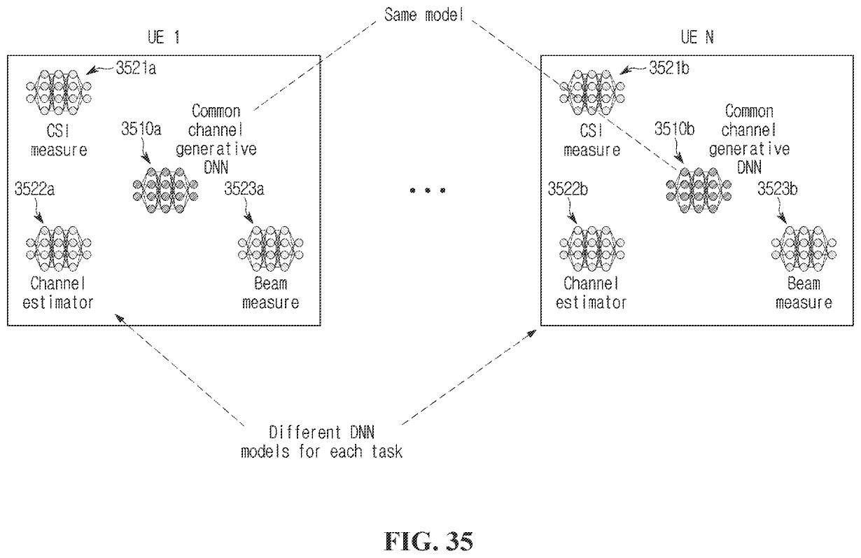

FIG. 34 illustrates other examples of context groups according to an embodiment of the present disclosure. FIG. 34 exemplifies two terminal context groups 3401 and 3402 allocated to a same area. Both the two terminal context groups 3401 and 3402 are allocated to a cell of a base station 3420. Herein, a terminal context is discriminated by mobility as a main factor. A first terminal 3410-1 with high mobility and a second terminal 3410-2 with low mobility and a probability distribution, which has a frequent change of posture, have different contexts. Accordingly, the first terminal 3410-1 and the second terminal 3410-2 have different latent distributions p1(z) and p2(z).

According to the above-described various embodiments, online learning performance degradation may be minimized in the idle state of a physical layer terminal consisting of neural networks. It is because, even when a terminal enters a power saving mode and moves at the same time, a training sample may be provided to a neural network in charge of a channel-related task. In addition, an online learning period may be adjusted through uncertainty measurement. In addition, the proposed technology provides a trade-off relationship between power consumption reduction and neural network performance. Especially, according to various embodiments, as compared to a method of updating a discriminative neural network, latent distribution information occupying a smaller amount of information of a channel generative network is delivered, and thus wireless resource consumption for online learning may be minimized.

FIG. 32 illustrates examples of timesteps at which context measurement and online learning are performed during a DRX cycle according to an embodiment of the present disclosure. In the example of FIG. 32, a DRX cycle has a length of 1.28 seconds. Referring to FIG. 32, monitoring is periodically performed for a terminal context during wake-up durations 3202-1 and 3202-2. If the context is changed, a latent distribution is updated through proposed signaling. In addition, online learning is performed during sleep durations 3204-1 and 3204-2.

As the examples of the proposal method described above may also be included in one of the implementation methods of the present disclosure, it is an obvious fact that they may be considered as a type of proposal methods. In addition, the proposal methods described above may be implemented individually or in a combination (or merger) of some of them. A rule may be defined so that information on whether or not to apply the proposal methods (or information on the rules of the proposal methods) is notified from a base station to a terminal through a predefined signal (e.g., a physical layer signal or an upper layer signal).

The present disclosure may be embodied in other specific forms without departing from the technical ideas and essential features described in the present disclosure. Therefore, the above detailed description should not be construed as limiting in all respects and should be considered as an illustrative one. The scope of the present disclosure should be determined by rational interpretation of the appended claims, and all changes within the equivalent scope of the present disclosure are included in the scope of the present disclosure. In addition, claims having no explicit citation relationship in the claims may be combined to form an embodiment or to be included as a new claim by amendment after filing.

### INDUSTRIAL APPLICABILITY

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1-18. (canceled)

19. A method comprising:
receiving broadcast information necessary for communication;
transmitting capability information related to discontinuous reception (DRX);
receiving configuration information related to the DRX;
performing a sleep duration operation based on the configuration information; and
performing an on-duration operation based on the configuration information,
wherein the on-duration operation includes an operation of monitoring a user equipment (UE) context that is used to configure a receiver, and
wherein the sleep duration operation includes an operation of configuring the receiver by using channel data that is generated based on the UE context.

20. The method of claim 19, wherein the capability information includes at least one of information indicating whether online learning is capable of being performed during a DRX operation, information indicating whether channel data is capable of being generated, and information indicating at least one supportable terminal context item.

21. The method of claim 19, wherein the receiver includes at least one neural network model for performing at least one task related to a reference signal, and
wherein a configuration for the receiver uses the channel data as learning data for the at least one neural network model.

22. The method of claim 19, further comprising generating the channel data based on a latent distribution corresponding to the UE context,
wherein the channel data includes at least one of channel information based on a latent vector corresponding to the UE context, reference signals that pass a channel specified by the channel information, or a pattern of the reference signals.

23. The method of claim 22, wherein the performing of the sleep duration comprises:
deactivating at least one physical layer hardware; and
performing, without receiving an external signal, online learning for at least one neural network model included in the receiver by using the channel data.

24. The method of claim 22, wherein the latent distribution is determined based on the broadcast information, and
wherein the broadcast information includes information related to a condition for selecting context groups respectively.

25. The method of claim 19, further comprising:
transmitting a first message for requesting probability distribution information that is used to generate channel data for a context group corresponding the UE context; and
receiving a second message including the probability distribution information.

26. The method of claim 19, further comprising:
transmitting a message for requesting transmission of reference signals to a base station, based on uncertainty for the channel data exceeding a threshold;
receiving the reference signals; and
performing, based on the reference signals, training for the at least one neural network model included in the receiver.

27. The method of claim 19, further comprising:
determining uncertainty for the channel data; and
determining, based on the uncertainty, a training period for the at least one neural network model included in the receiver.

28. A method comprising:
transmitting broadcast information necessary for communication;
receiving capability information related to discontinuous reception (DRX);
transmitting configuration information related to the DRX;
receiving a message for requesting information or a signal necessary for configuring a receiver of a user equipment (UE); and
transmitting the information or the signal,
wherein the configuration information indicates a sleep duration and an on-duration for a DRX operation of the UE,
wherein the on-duration is used to monitor a UE context that is used to configure the receiver in the UE, and
wherein the sleep duration is used to configure the receiver by using channel data that is generated in the UE based on the UE context.

29. The method of claim 28, wherein the message includes at least one of information related to a UE context of the UE, information related to a context group of the UE, information related to a task of a receiver model to be trained, information related to uncertainty, or information related to a channel generative model of the UE.

30. The method of claim 28, wherein the capability information includes at least one of information indicating whether online learning is capable of being performed during a DRX operation, information indicating whether channel data is capable of being generated, and information indicating at least one supportable terminal context item.

31. The method of claim 28, wherein the transmitting of the information or the signal comprises transmitting information related to a latent distribution corresponding to a changed UE context or a changed context group of the UE.

32. The method of claim 28, wherein the transmitting of the information or the signal comprises transmitting reference signals having a pattern that is selected according to uncertainty sampling.

33. A user equipment (UE) in a wireless communication system, the UE comprising:
a transceiver; and
a processor coupled with the transceiver,
wherein the processor is configured to:
receive broadcast information necessary for communication,
transmit capability information related to discontinuous reception (DRX),
receive configuration information related to the DRX,
perform a sleep duration operation based on the configuration information, and
perform an on-duration operation based on the configuration information,
wherein the on-duration operation includes an operation of monitoring a UE context that is used to configure a receiver, and
wherein the sleep duration operation includes an operation of configuring the receiver by using channel data that is generated based on the UE context.

34. The UE of claim 33, wherein the capability information includes at least one of information indicating whether online learning is capable of being performed during a DRX operation, information indicating whether channel data is capable of being generated, and information indicating at least one supportable terminal context item.

35. The UE of claim 33, wherein the receiver includes at least one neural network model for performing at least one task related to a reference signal, and
wherein a configuration for the receiver uses the channel data as learning data for the at least one neural network model.

36. The UE of claim 33, wherein the processor is further configured to:
generate the channel data based on a latent distribution corresponding to the UE context,
wherein the channel data includes at least one of channel information based on a latent vector corresponding to the UE context, reference signals that pass a channel specified by the channel information, or a pattern of the reference signals.

37. The UE of claim 36, wherein the latent distribution is determined based on the broadcast information, and
wherein the broadcast information includes information related to a condition for selecting context groups respectively.

38. The UE of claim 33, wherein the processor is further configured to:
transmit a first message for requesting probability distribution information that is used to generate channel data for a context group corresponding the UE context; and
receive a second message including the probability distribution information.
